(19) United States
(12) Patent Application Publication
(10) Pub. No.: US 2010/0327655 A1
(43) Pub. Date: Dec. 30, 2010

(54) POWER SUPPLY APPARATUS

(76) Inventors: Shinichiro Okamoto, Ibaraki-shi (JP); Takuya Kagawa, Muko-shi (JP); Hiroaki Koshin, Toyonaka-shi (JP)

Correspondence Address: Cheng Law Group, PLLC, 1100 17th Street, N.W., Suite 503, Washington, DC, 20036, US

(21) Appl. No.: 12/918,966

(22) PCT Filed: Feb. 25, 2009
(86) PCT No.: PCT/JP2009/053453

§ 371 Date: Aug. 23, 2010

(30) Foreign Application Priority Data
Feb. 26, 2008 (JP) 2008-045303

(51) Int. Cl. H02J 1/10; H02J 3/46

(52) U.S. Cl. 307/24

(57) ABSTRACT

A power supply apparatus (10) includes one first power device (30) and a plurality of second power devices (41, 42, and 43). The power supply apparatus is configured to operate simultaneously the first power device (30) and the plurality of the second power devices (41, 42, and 43) to supply a DC power therefrom to a load device (92). The first power device (30) has its output voltage of a DC voltage kept constant irrespective of a magnitude of an output current of the first power device (30). The second power devices (41, 42 and 43) have its output voltage of a DC voltage which decreases monotonically as an output current of the second power devices (41, 42, and 43) increases, respectively. The second power devices (41, 42, and 43) include an adjustment unit configure to adjust the output current in accordance with an instruction value for prescribing a magnitude of the output current. The adjustment unit is configured to, upon receiving the instruction value, modify the output current-output voltage characteristics of the second power device under a condition where the output voltage of the second power device decreases monotonically as the output current of the second power device increases, thereby adjusting the output current of the second power device to a current corresponding to the received instruction value as well as adjusting the output voltage of the second power device corresponding to the adjusted output current of the second power device to the output voltage of the second power device corresponding to the unadjusted output current of the second power device.

### TECHNICAL FIELD

The present invention is directed to power supply apparatuses configured to supply a DC power to a load device, more specifically to a power supply apparatus which includes a plurality of power devices configured to provide an output voltage of DC voltage and is configured to operate simultaneously the plurality of the power devices to supply a DC power therefrom to a load device to which the power devices are connected.

### BACKGROUND ART

In the past, there have been proposed power supply apparatuses which simultaneously operate a plurality of power devices to supply a DC power therefrom to a load device to which the power devices are connected.

For example, there is the power supply apparatus including all the power devices which make a constant voltage control. In this power supply apparatus, all the power devices are configured to output the same output voltage.

However, in a practical sense, it is difficult to adjust accurately the output voltages of all the power devices to be the same. Therefore, the power supply apparatus is likely to have a difference between the output voltages of the power devices. Consequently, in the aforementioned power supply apparatus, only the power device having the highest output voltage supplies a DC power to the load device in accordance with its available power capacity. In this situation, when the power device having the highest output voltage fails to supply enough power to the load device, the remaining power devices supplement a shortage of power supply. Thus, in this power supply apparatus, the power device having the highest output voltage, that is, the particular power device is intensively used. Therefore, an advantage obtained from operating simultaneously the plurality of the power devices is reduced.

In order to solve the above problem, there has been proposed a power supply apparatus including two power devices which decrease monotonically its output voltage with an increase of its output current (see Japanese patent laid-open publication No. 10-24823). In this power supply apparatus, the two power devices shows individual output current-output voltage characteristics of which lines have different gradient from each other. This means that, when the two power devices varies their output current by the same extent, one of the power devices shows a variation of the output voltage different from that of the other power device.

In this power supply apparatus, each of the power devices operates to reach a balance point determined by its output current-output voltage characteristics and the load current in accordance with a magnitude of a consumed current (load current) of the load device. Therefore, each of the power devices can output the desired output voltage and output current.

However, in this power supply apparatus, the output voltages (that is, supply voltages for the load current) of each of the power device are varied due to a magnitude of the load current. Therefore, the power supply apparatus fails to output the stable supply voltage. In this power supply apparatus, in order to keep the supply voltage to the load device at a constant level irrespective of changes of the output currents of the each of the power devices, both of the power supply apparatus have to vary their output current-output voltage characteristics. For satisfying this requirement, the power supply apparatus needs to have a more complex configuration.

Now, in order to solve the above problem, one of the power devices which are operated simultaneously can make a constant voltage control, and the remaining power devices can make a constant current control. In the power supply apparatus including the power device of the constant voltage control and the power device of the constant current control, the power device of the constant current control has the predetermined output current. The power device of the constant current control supplies the predetermined output current to the load current while having its output voltage identical to an output voltage (reference voltage) of the power device of the constant voltage control. In this situation, the power device of the constant voltage current supplements a shortage of the load current. Therefore, the supplied voltage for the load device is kept constant voltage (the output voltage of the power device of the constant voltage control) even when the load current is varied. Consequently, this power supply apparatus can successfully supply power to the load current.

However, in this power supply apparatus, when the power device of the constant voltage control loses its available power capacity (e.g. in a case of the power device being connected to a commercial power source, a power failure or instantaneous power failure of the commercial power source occurs), the reference voltage for determining the magnitude of the output voltage of the power device of the constant current control disappears. Therefore, the power device of the constant current control gives its output voltage which is likely to increase extremely to an excess voltage, or decrease extremely to a short voltage.

### DISCLOSURE OF INVENTION

In view of the above insufficiency, the present invention has been aimed to propose a power supply apparatus which is capable of successfully supplying power to a load device by means of its function of adjusting the output currents of each of power devices while keeping a supply voltage to the load device constant irrespective of a variation of a load current and available power capacity of the power device, when operating simultaneously a plurality of the power devices.

A power supply apparatus in accordance with the present invention includes a plurality of power devices, each of said power devices being configured to provide an output voltage of a DC voltage. The power supply apparatus is configured to operate simultaneously the plurality of the power devices to supply a DC power therefrom to a load device to which the power devices are connected. The plurality of the power devices includes a first power device and a second power device. The first power device is configured to have output current-output voltage characteristics of keeping an output voltage of the first power device constant irrespective of a magnitude of an output current of the first power device. The second power device is configured to have output current-output voltage characteristics of decreasing monotonically an output voltage of the second power device with an increase of an output current of the second power device. The second power device includes an adjustment unit configure to adjust the output current of the second power device in accordance with an instruction value. The adjustment unit is configured to, upon receiving the instruction value, modify the output current-output voltage characteristics under a condition where the output voltage decreases monotonically as the output current increases, thereby adjusting the output current to a current corresponding to the received instruction value as well as adjusting the output voltage corresponding to the adjusted output current to the output voltage corresponding to the unadjusted output current.

According to the present invention, even if the load current (consumed current) of the load device side is varied, or even if a supply capacity of the second power device is varied, it is possible to adjust a magnitude of the output current of the second power device while the output voltage of the second power device is kept constant because the adjustment unit modifies the output current-output voltage characteristics of the second power device. Therefore, it is possible to successfully supply power to the load device.

In a preferred embodiment, the second power device includes a control unit configured to output the instruction value. The instruction value is defined to prescribe a magnitude of the output current of the second power device.

According to this embodiment, it is possible to easily modify the output current-output voltage characteristics of the second power device by means of outputting the instruction value from the control unit to the second power device.

In a preferred embodiment, the adjustment unit is configured to modify the output current-output voltage characteristics of the second power device by adjusting the output voltage of the second power device to a voltage obtained by addition of a predetermined voltage to or subtraction of the same from the unadjusted output voltage of the second power device such that the output current of the second power device given in accordance with the modified output current-output voltage characteristics becomes corresponding to the instruction value when the output voltage of the second power device is identical to the output voltage of the first power device.

According to the embodiment, it is possible to easily adjust a magnitude of the output current of the second power device in conformity with the instruction value, irrespective of a change of the load current.

In a more preferred embodiment, the first power device includes an AC/DC converter configured to convert a source voltage received from a commercial power source into the DC voltage.

According to this embodiment, the first power device receives the source voltage from the commercial power source supplying stable power. Therefore, it is possible to reduce an influence of a load variation caused by an on-off operation of the load device. Thus, it is possible to more successfully supply power to the load device.

In a more preferred embodiment, the second power device includes a current detector, a voltage detector, a DC/DC converter, and a switching controller. The current detector is configured to detect the output current of the second power device. The voltage detector is configured to detect the output voltage of the second power device. The DC/DC converter includes a switching device and configured to make a power conversion by an on-off operation of the switching device. The switching controller is configured to send to the switching device a pulse width modulated signal for controlling the on-off operation of the switching device such that the second power device has a particular output current-output voltage characteristics of decreasing monotonically the output voltage of the second power device with an increase of the output current of the second power device, on the basis of a detection result of the output current detector and a detection result of the output voltage detector.

According to the embodiment, the second power device can be manufactured by sharing most parts of the first power device only with exception of few additional parts. Therefore, the second power device can be implemented only by slight modification to the configuration of the first power device.

In a more preferred embodiment, the adjustment unit is configured to calculate a difference value between a value corresponding to the received instruction value and the detection result of the current detector, and output the calculated difference value to the switching controller. The switching controller is configured to modify a duty ratio of the pulse width modulation signal depending on the received difference value and the detection result of the voltage detector.

According to the embodiment, it is possible to easily adjust a magnitude of the output current of the second power device.

In a more preferred embodiment, the adjustment unit is configured to calculate an error between the detection result of the current detector and a value corresponding to the instruction value. The adjustment unit is configured to correct the output current-output voltage characteristics to reduce the calculated error under the condition where the output voltage decreases monotonically as the output current increases.

According to the embodiment, the actual output current is fed back to correct the error between the actual output current and the output current corresponding to the instruction value. Therefore, it is possible to improve the accuracy of the output current of the second power device.

In a more preferred embodiment, the adjustment unit is configured to modify the output current-output voltage characteristics to reduce an increase rate of the output voltage relative to a decrease of the output current when the output voltage of the second power device becomes equal to a prescribed threshold.

According to the embodiment, it is possible to restrain a surge of the output voltage which would otherwise occur due to decreased load current. Therefore, the voltage applied to the load device can be restrained from excessively increasing.

### BRIEF DESCRIPTION OF DRAWINGS

FIG. 1 is a block diagram illustrating a primary part of a power supply apparatus of a first embodiment,

FIG. 2 is a schematic view illustrating a DC distribution system where the above power supply device is applied,

FIG. 3 is a circuit diagram illustrating a first power device of the above power supply apparatus,

FIG. 4 is a circuit diagram illustrating a second power device of the above power supply apparatus,

FIG. 5A is a diagram illustrating output current-output voltage characteristics of the second power device of the above power supply apparatus,

FIG. 5B is a diagram illustrating output current-output voltage characteristics of the first power device of the above power supply apparatus,

FIG. 5C is an explanatory view illustrating an output current of the second power device of the above power supply apparatus,

FIG. 6 is an explanatory view illustrating an operation of the second power device of the above power supply apparatus,

FIG. 7 is an explanatory view illustrating a variation of the output current-output voltage characteristics of the second power device of the above power supply apparatus,

FIG. 8 is a block diagram illustrating a primary part of a power supply apparatus of a second embodiment,

FIG. 9 is a diagram illustrating output current-output voltage characteristics of the power supply apparatus of a third embodiment,

FIG. 10 is a block diagram illustrating a primary part of the above power supply apparatus,

FIG. 11 is a diagram illustrating output current-output voltage characteristics of the power supply apparatus of a fourth embodiment,

FIG. 12 is a block diagram illustrating a primary part of a power supply apparatus of a fifth embodiment,

FIG. 13 is a diagram illustrating output current-output voltage characteristics of an AC/DC converter, a PV converter, and a BAT converter of the above power supply apparatus,

FIG. 14 is a circuit diagram illustrating a second power device of a power supply apparatus of a sixth embodiment,

FIG. 15 is a block diagram illustrating a primary part of the above power supply apparatus,

FIG. 16 is an explanatory view illustrating a function of a second power device of the above power supply apparatus,

FIG. 17 is a block diagram illustrating a primary part of a power supply apparatus of a seventh embodiment,

FIG. 18 is a block diagram illustrating a primary part of a power supply apparatus of an eighth embodiment, and

FIG. 19 is a block diagram illustrating a primary part of a power supply apparatus of a ninth embodiment.

### BEST MODE FOR CARRYING OUT THE INVENTION

### First Embodiment

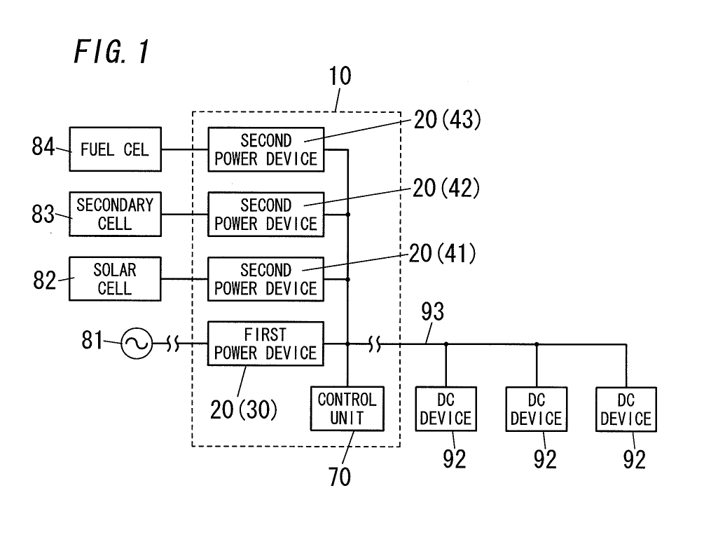

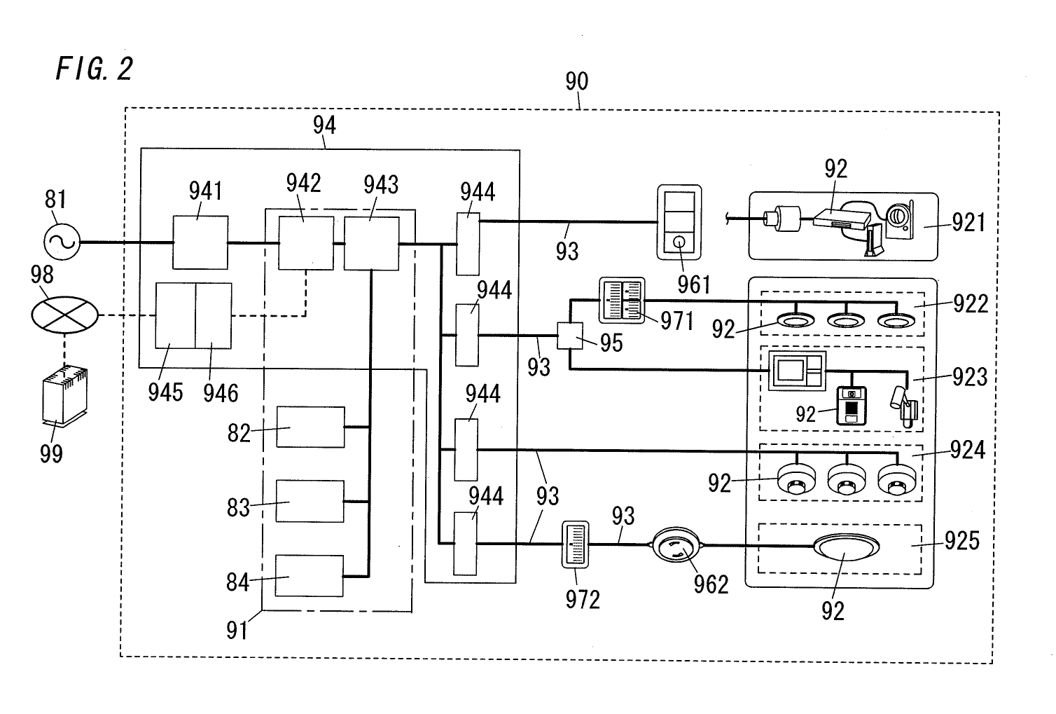

In the embodiment explained below, a house 90 (see FIG. 2) of a single-family dwelling is exemplified as a building where a DC distribution system, where a power supply apparatus 10 (see FIG. 1) of the present invention is applied, is installed. It is noted that the power supply apparatus 10 in accordance with the present invention can be applied to either a house of a single-family dwelling or a housing complex.

As shown in FIG. 2, there are a DC power supply unit 91 configured to output DC power and the DC device 92 placed in the house 90. The DC device 92 is a load (load device) activated by DC power. DC power is supplied to the DC device 92 via a DC supply line 93 connected to an output terminal of the DC power supply unit 91. There is a DC breaker 944 interposed between the DC power supply unit 91 and the DC device 92. The DC breaker 944 is configured to monitor current flowing through the DC supply line 93 and to limit or terminate electrical power supply from the DC power supply unit 91 to the DC device 92 via the DC supply line 93 upon detecting an abnormal state.

The DC supply line 93 is adopted as a power line for DC power as well as a communication line. For example, it is possible to communicate between devices connected to the DC supply line 93 by means of superimposing on a DC voltage a communication signal used for transmitting a data and made of a high-frequency carrier. This technique is similar to a power line communication technique where a communication signal is superimposed on an AC voltage applied to a power line for supplying an AC power.

The aforementioned DC supply line 93 is connected to a home server 945 via the DC power supply unit 91. The home server 945 is a primary device for constructing a home communication network (hereinafter called “home network”). The home server 945 is configured to communicate with a subsystem constructed by the DC device 92 in the home network, for example.

In the instance shown in FIG. 2, an information system 921, lighting systems 922 and 925, an entrance system 923, and a home alarm system 924 are adopted as the subsystem. The each subsystem is an autonomous distributed system, and operates by itself. The subsystem is not limited to the aforementioned instance.

The DC breaker 944 is associated with the subsystem. In the instance shown in FIG. 2, each of the information system 921, a pair of the lighting system 922 and entrance system 923, the home alarm system 924, and the lighting system 925 is associated with one DC breaker 944. A connection box 95 is provided to associate one DC breaker 944 with a plurality of the subsystems. The connection box 95 is configured to divide a system of the DC supply line for each subsystem. In the instance shown in FIG. 2, the connection box 95 is interposed between the lighting system 922 and the entrance system 923.

The information system 921 includes the informational DC device 92 such as a personal computer, a wireless access point, a router, and an IP telephone transceiver. This DC device 92 is connected to a DC socket 961 preliminarily provided to the house 90 (provided at the time of constructing the house 90) as a wall outlet or a floor outlet, for example.

Each of the lighting systems 922 and 925 includes the lighting DC device 92 such as a lighting fixture. In the instance shown in FIG. 2, the lighting system 922 includes the lighting fixture (DC device 92) preliminarily provided to the house 90. It is possible to send a control instruction to the lighting fixture of the lighting system 922 by use of an infrared remote controller. Further, the control instruction can be sent by transmitting a communication signal from a switch 971 connected to the DC supply line 93. In short, the switch 971 has a function of communicating with the DC device 92. In addition, the control instruction can be sent by transmitting a communication signal from the home server 945 or other DC device 92 of the home network. The control instruction for the lighting fixture indicates such as turning on, turning off, dimming, and blinking. Meanwhile, the lighting system 925 includes the lighting fixture (DC device 92) connected to a ceiling-mounted hooking receptacle 962 preliminarily provided on a ceiling. It is noted that the lighting fixture is attached to the ceiling-mounted hooking receptacle 962 by a contractor at the time of constructing an interior of the house 90 or attached to the ceiling outlet 962 by a resident of the house 90. In addition, a switch 972 is interposed between the ceiling-mounted hooking receptacle 962 and the DC breaker 944. The switch 972 is used to turning on and off the DC device 92 such as a lighting apparatus connected to the ceiling-mounted hooking receptacle 962.

The entrance system 923 includes the DC device 92 configured to respond to a visitor and to monitor an intruder.

The home alarm system 924 includes the alarming DC device 92 such as a fire alarm.

Any DC device 92 can be connected to each of the aforementioned DC outlet 961 and ceiling-mounted hooking outlet 962. Each of the DC outlet 961 and ceiling-mounted hooking receptacle 962 outputs DC power to the connected DC device 92. Therefore, the DC outlet 961 and ceiling-mounted hooking receptacle 962 are hereinafter collectively called the “DC outlet”, when a distinction between the DC outlet 961 and the ceiling-mounted hooking receptacle 962 is unnecessary. A case of the DC outlet has a connection slot (plug-in connection slot) for inserting a terminal of the DC device 92. A terminal receiving member configured to directly contact to the terminal which is inserted into the connection slot is housed in the case of the DC outlet. In short, the DC outlet with above mentioned configuration makes contact-type power supply. The DC device with a communication function is capable of transmitting a communication signal via the DC supply line 93. The communication function is provided to not only the DC device 92 but also DC outlet. It is noted that the terminal is directly attached to the DC device 92 or is attached to the DC device 92 via a connection wire.

The home server 945 is connected to not only the home network but also the wide area network 98 constructing Internet. While the home server 945 is connected to the wide area network 98, a user can enjoy service provided by a center server (computer server) 99 connected to the wide area network.

The center server 99 provides service capable of monitoring or controlling a device (which is mainly the DC device 92, but which may be other apparatus having a communication function) connected to the home network via the wide area network 98, for example. The service enables monitoring or controlling a device connected to the home network by use of a communication terminal (not shown) having a browsing function such as a personal computer, an internet TV, and a mobile telephone equipment.

The home server 945 has a function of communicating with the center server 99 connected to the wide area network 98 and a function of communicating with a device connected to the home network. The home server 945 further has a function of collecting identification information (e.g. IP address) concerning a device connected to the home network. The home server 945 and center server 99 mediate a communication between a home device and a communication terminal in the wide area network 98. Therefore, it is possible to monitor or control the home device by use of the communication terminal.

When a user attempts to monitor or control the home device by use of the communication terminal, the user controls the communication terminal so as to store a monitoring request or a control request in the center server 99. The device placed in the house establishes periodically one-way polling communication, thereby receiving the monitoring request or control request from the communication terminal. According to the aforementioned operation, it is possible to monitor or control the device placed in the house by use of the communication terminal. When an event (such as fire detection) of which the home device should notify the communication terminal occurs, the home device notifies the center server 99 of occurrence of the event. When the center server 99 is notified of the occurrence of the event by the home device, the center server 99 notifies the communication terminal of the occurrence of the event by use of an e-mail.

A function of communicating with the home network of the home server 945 includes an important function of detecting and managing a device constructing the home network. By means of utilizing UPnP (Universal Plug and Play), the home server 945 automatically detects a device connected to the home network. The home server 945 further includes a display device 946 having a browsing function, and controls the display device 946 to display a list of the detected device. The display device 946 includes a touch panel or another user interface unit. Therefore, it is possible to select a desired one from options displayed on a screen of the display device 946. Accordingly, a user (a contractor or a resident) of the home server 945 can monitor and control the device through the screen of the display device 946. The display device 946 may be separated from the home server 945.

The home server 945 manages information with relation to connection of a device. For example, the home server 945 stores a type or a function and an address of the device connected to the home network. Therefore, it is possible to make a linked operation between devices of the home network. As described in the above, the information with relation to connection of a device is automatically detected. In order to make the linked operation between the devices, it is sufficient that an association between devices is automatically made by an attribution of a device. An information terminal such as a personal computer may be connected to the home server 945. In this case, the association between devices can be made by use of a browsing function of the information terminal.

Each of the devices holds a relation with regard to the linked operations between the devices. Therefore, the devices can make the linked operation without requiring to access to the home server 945. After establishing an association with regard to the linked operation of respective devices, a lighting fixture, which is one of the devices, is caused to turn on and off by manipulation of a switch, which is another of the devices, for example. Although the association with regard to the linked operation is made for the devices belonging to the same subsystem, the association with regard to the linked operation may be made for the devices belonging to the different subsystems.

The DC supply unit 91 is configured to basically generate DC power from AC power supplied from an AC power source, for example a commercial power source 81 located outside. In the instance shown in FIG. 2, the AC power source 81 is connected to an AC/DC converter 942 including a switching regulator via a main breaker 941. The main breaker 941 is embedded in a distribution board 94. DC power output from the AC/DC converter 942 is supplied to each DC breaker 944 via a cooperation control unit 943.

The DC supply unit 91 is provided with a secondary cell 83 in view of a period (blackout period of the commercial power source) in which the DC supply unit 91 fails to receive electrical power from the AC power source 81. In the DC supply unit 91, a solar cell 82 and fuel cell 84 configured to generate DC power can be used together with the secondary cell 83. The solar cell 82, secondary cell 83, and fuel cell 84 respectively are a dispersed power source in view of a main power source including the AC/DC converter 942. In the instance shown in FIG. 2, the solar cell 82, secondary cell 83, and fuel cell 84 respectively include a circuit unit configured to control its output voltage. The solar cell 82 further includes not only a circuit unit of controlling electrical discharge but also a circuit unit of controlling electrical charge.

Although the solar cell 82 and fuel cell 84 of the dispersed power sources are dispensable, the secondary cell 83 is preferred to be provided. The secondary cell 83 is charged by the main power source or the other dispersed power source at the right time. The secondary cell 83 is discharged during a period in which the DC supply unit 91 fails to receive electrical power from the AC power source 81. In addition, the secondary cell 83 is discharged at the right time as necessary. The cooperation control unit 943 is configured to control discharge and charge of the secondary cell 83 and to make cooperation between the main power source and the dispersed power source. In short, the cooperation control unit 943 functions as a DC power control unit configured to control distributing to the DC device 92 electrical power from the main power source and dispersed power source constituting the DC supply unit 91. It is noted that DC power from the solar cell 82, secondary cell 83, and fuel cell 84 may be input to the AC/DC converter 942 by converting into AC power.

A drive voltage of the DC device 92 is selected from different voltages respectively suitable to individual devices of different voltage requirements. For this purpose, the cooperation control unit 943 is preferred to include a DC/DC converter configured to convert DC voltage from the main power source and dispersed power source into a desired voltage. Normally, a fixed voltage is applied to one subsystem (or the DC device 92 connected to one particular DC breaker 944). 90owever, different voltages may be selectively applied to one subsystem by use of three or more lines. Use of two wired DC supply line 93 can vary the voltage applied between wires with time. The DC/DC converter can be placed at plural points in a similar fashion as the DC breakers 944.

In the instance shown in FIG. 2, only one AC/DC converter 942 is provided. However, a plurality of AC/DC converters 942 may be connected in parallel to each other. When the plurality of the AC/DC converters 942 is provided, it is preferred to vary the number of the AC/DC converters 942 being activated in accordance with a magnitude of the load.

The aforementioned AC/DC converter 942, cooperation control unit 943, DC breaker 944, solar cell 82, secondary cell 83, and fuel cell 84 respectively are provided with a communication function. Therefore, the linked operation can be performed in response to status of each of the main power source, dispersed power source, and loads including the DC device 92. Like a communication signal used for the DC device 92, a communication signal used by the communication function is transmitted by being superimposed on DC voltage.

In the instance shown in FIG. 2, in order to convert AC power output from the main breaker 941 into DC power, the AC/DC converter 942 is placed in the distribution panel 94. 90owever, the AC/DC converter 942 is not necessarily placed in the distribution panel 94. For example, branch breakers (not shown) may be connected to an output side of the main breaker 941 in the distribution panel 94 such that a plurality of systems is branched off from an AC supply line, and an AC/DC converter may be provided to an AC supply line of each of the systems. That is, each system may be provided with an apparatus configured to convert AC power into DC power. In this instance, it is possible to provide the DC supply unit 91 to each unit such as a floor or room of the house 90. Accordingly, it is possible to manage the DC supply unit 91 for each system. In addition, it is possible to shorten a distance between the DC supply unit 91 and the DC device 92 configured to utilize DC power. Therefore, it is possible to reduce power loss caused by a voltage drop which occurs in the DC supply line 93. Alternatively, the main breaker 941 and branch breaker may be housed in the distribution panel 94, and the AC/DC converter 942, cooperative control unit 943, DC breaker 94, and home server 945 may be placed in another panel different from the distribution panel 94.

Next, an explanation is made to a power supply apparatus 10 of the first embodiment of the present invention with reference to FIG. 1. The power supply apparatus 10 includes a plurality (four, in the present embodiment) of power devices 20 configured to apply an output voltage of a DC voltage. The power supply apparatus 10 is configured to simultaneously operate the plurality of the power devices 20 to supply a DC power to the DC device (load device) 92 to which the power devices 20 are connected. In the instance shown in FIG. 2, the power supply apparatus 10 can be adopted as the DC power supply unit 91.

Herein, one of the power devices 20 is a first power device, and the remaining power devices 20 are second power devices. In a following explanation, in order to distinguish the first power device and the respective second power devices, the first power device is designated by the reference number of 30, and the second power devices are designated by the reference numbers of 41 to 43, respectively, as necessary. When the second power devices 41 to 43 need not be distinguished from each other, the second power device is designated by the reference number of 40.

As described in the above, the power supply apparatus 10 includes the one first power device 30 and the plurality (three, in the present embodiment) of the second power devices 40. In the following explanation, although lout denotes an output current of the power device 20, the output current of the first power device 30 is designated by Ioa, and the output currents of the second power devices 41, 42, and 43 are designated by Iob, Ioc, and Iod, respectively, as necessary. Likewise, although Vout denotes an output voltage of the power device 20, the output voltage of the first power device 30 is designated by Voa, and the output voltages of the second power devices 41, 42, and 43 are designated by Vob, Voc, and Vod, respectively, as necessary.

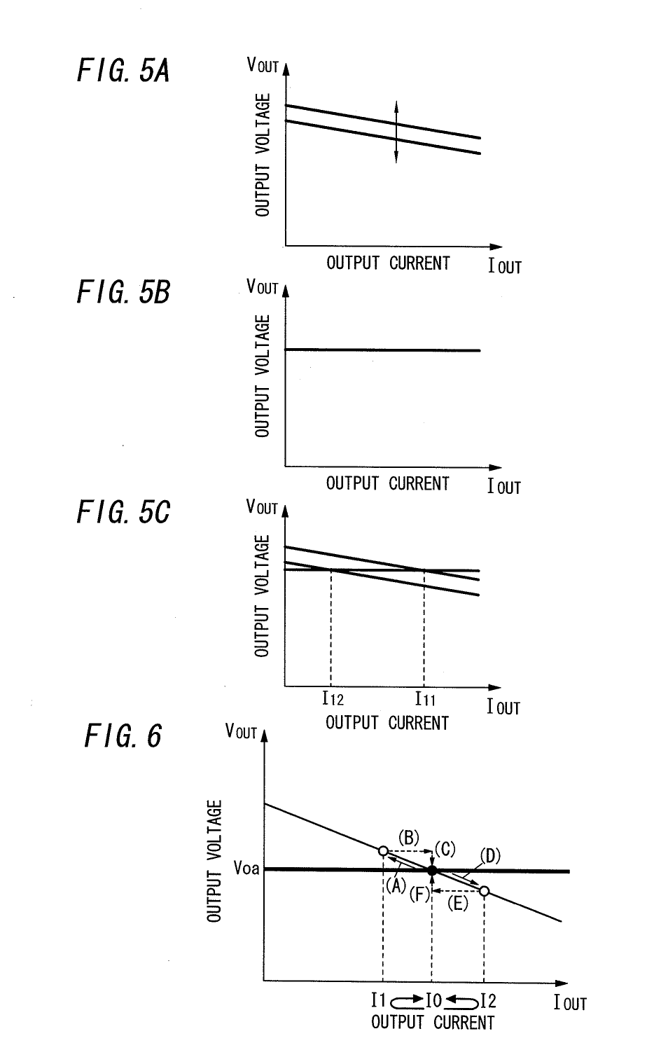

The first power device 30 is configured to provide the output voltage Vout of a DC voltage which is a constant voltage irrespective of a magnitude of the output current Iout (see FIG. 5B). That is, the first power device 30 is configured to have output current-output voltage characteristics of keeping the output voltage Vout of the first power device 30 constant irrespective of a magnitude of the output current Iout of the first power device 30. For example, the first power device 30 receives an input voltage Vin of a DC voltage generated from a source voltage of the commercial power source 81. It is noted that the first power device 30 may receive the input voltage Vin of the source voltage of the commercial power source 81. With this arrangement, the first power device 30 includes an AC/DC converter configured to convert the source voltage of the commercial power source 81 into a DC voltage.

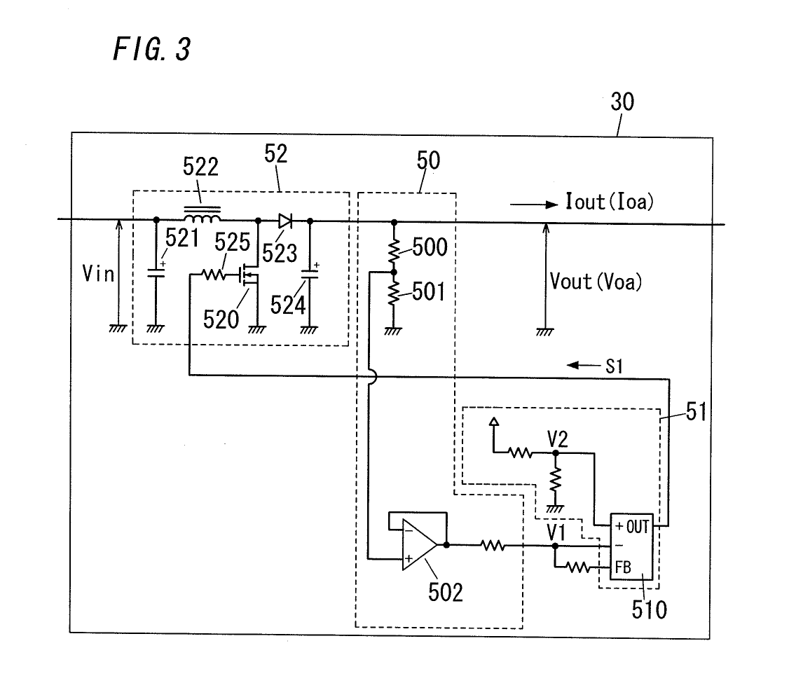

As shown in FIG. 3, the first power device 30 includes a voltage detector 50, a switching controller 51, and a DC-DC converter 52.

The voltage detector 50 is configured to detect the output voltage Vout (Voa) of the first power device 30. For example, the voltage detector 50 includes two resistors 500 and 501 connected in series and a voltage follower 502 configured to receive a divided voltage generated by the resistors 500 and 501.

The switching controller 51 includes a switching IC 510 configured to receive a detection voltage (output voltage of the voltage follower 502) V1 of the voltage detector 50 as well as a reference voltage V2.

The switching IC 510 is configured to output to a switching device 520 a pulse width modulation signal S1 which has its duty ratio selected such that a difference voltage (V2−V1) between the detection voltage V1 and the reference voltage V2 is kept constant. That is, the switching IC 510 is configured to select the duty ratio of the pulse width modulation signal S1 such that the output voltage Vout (detection voltage V1) is kept constant.

As seen from the above, the switching controller 51 is configured to generate the pulse width modulation signal S1 which has its duty ratio selected based on the reference voltage V2 and the detection voltage V1 of the voltage detector 50.

DC-DC converter 52 includes a smoothing capacitor 521, an inductor 522, the switching device 520, a diode 523, and a smoothing capacitor 524 which are arranged in this order from its input side (left side, in FIG. 3). The DC-DC converter 52 operates to turn on and off the switching device 520 for increasing the input voltage Vin.

For example, the switching device 520 is a field-effect transistor. The switching device 520 has its gate receiving the pulse width modulation signal S1 from the switching IC 510 via a resistor 525. Therefore, the switching device 520 is turned on and off in accordance with the duty ratio of the pulse width modulation signal S1 from the switching controller 51. While the switching device 520 is turned on, the switching device 520 has its source electrically connected to its drain. Thereby, the inductor 522 continues to accumulate electromagnetic energy. Thereafter, when the switching device 520 is turned off, the inductor 522 discharges the accumulated electromagnetic energy. Thereby, the input voltage Vin is raised. The raised input voltage Vin is smoothed by the smoothing capacitor 524 and is output to the DC device 92 as the output voltage Vout.

The first power device 30 performs the aforementioned operation to make a feedback control to have the output current-output voltage characteristics of keeping the output voltage Vout of the first power device 30 constant irrespective of the magnitude of the output current Iout of the first power device 30, as shown in FIG. 5B.

The second power device 40 is configured to provide the output voltage Vout of a DC voltage which decreases monotonically as the output current Iout of the second power device 40 increases, as shown in FIG. 5A. That is, the second power device 40 is configured to have output current-output voltage characteristics of decreasing monotonically the output voltage Vout of the second power device 40 with an increase of the output current Iout of the second power device 40 (in other words, output current-output voltage characteristics of increasing monotonically the output voltage Vout of the second power device 40 with a decrease of the output current Iout of the second power device 40).

A line indicative of the output current-output voltage characteristics of the second power device 40 can be expressed as a relation of Vout=−a*Iout+V0 (a>0, V0>0). Wherein, V0 is constant, and satisfies a relation V0=Vout+a*Iout. Further, a indicates a gradient (a gradient of a line indicative of a relation between the output current Iout and the output voltage Vout). It is noted that a may be different in each of the second power devices 40 and may be common to the second power devices 40.

As shown in FIG. 1, the second power devices 41, 42, and 43 are connected to the solar cell 82, the secondary cell 83, and the fuel cell 84, respectively. The second power devices 40 receive output voltages from the corresponding cells 82, 83, and 84 as its input voltage Vin, respectively.

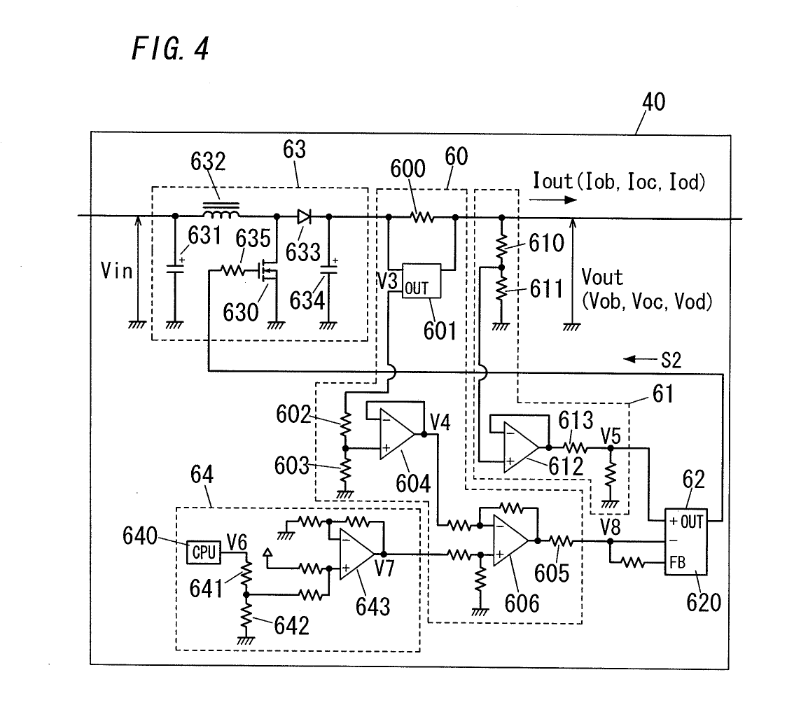

As shown in FIG. 4, the second power device 40 includes a current detector 60, a voltage detector 61, a switching controller 62, and a DC-DC converter 63. In addition, the second power device 40 includes an adjustment unit 64 configured to adjust the output current Iout (Iob, Ioc, Iod) in accordance with an instruction value.

The current detector 60 is configured to detect the output current Iout (Iob, Ioc, Iod) of the second power device 40. The current detector 60 of the present embodiment includes resistors 600 and 605, a current IC 601 configured to detect a voltage across the resistor 600, resistors 602 and 603 for dividing an output voltage V3 of the current IC 601, and a voltage follower 604 configured to receive a divided voltage generated by the resistors 602 and 603.

The voltage detector 61 is configured to detect the output voltage Vout (Vob, Voc, Vod) of the second power device 40. For example, the voltage detector 61 includes two resistors 610 and 611 connected in series and a voltage follower 612 configured to receive a divided voltage generated by the resistors 610 and 611.

The switching controller 62 is configured to generate a pulse width modulation signal S2 which has its duty ratio selected on the basis of the detection voltage (output voltage of the voltage follower 612) V5 of the voltage detector 61 and a voltage V8 output from the current detector 60. The switching controller 62 includes a switching IC 620 into which the detection voltage V5 of the voltage detector 61 and the voltage V8 are input.

DC-DC converter 63 includes a smoothing capacitor 631, an inductor 632, the switching device 630, a diode 633, and a smoothing capacitor 634 which are arranged in this order from its input side (left side, in FIG. 4). The DC-DC converter 52 operates to turn on and off the switching device 520 for increasing the input voltage Vin.

The adjustment unit 64 is configured to, upon receiving the instruction value, vary the output current-output voltage characteristics under the condition where the output voltage Vout decreases monotonically as the output current Iout increases, thereby adjusting the output current Iout to match a current corresponding to the received instruction value as well as adjusting the output voltage Vout corresponding to the adjusted output current Iout to match the output voltage Vout corresponding to the unadjusted output current Iout. The adjustment unit 64 of the present embodiment is configured to displace in parallel the line indicative of the output current-output voltage characteristics, thereby varying the output current-output voltage characteristics. That is, above V0 is varied while above a is fixed.

Next, an explanation is made to a detailed configuration of the adjustment unit 64. The adjustment unit 64 of the present embodiment includes a CPU 640 configured to obtain the instruction value prescribing the output current Iout from an after-mentioned control unit 70 (see FIG. 1). Further, the adjustment unit 64 includes two resistors 641 and 642 for dividing an output voltage V6 of the CPU 640 and a non-inverting amplifier circuit 643 into which a divided voltage generated by the resistors 641 and 642 are input.

The CPU 640 makes a control for varying the magnitude of the output current Iout on the basis of the instruction value received from the control unit 70 while the power supply apparatus 10 is in operation (the power supply apparatus 10 supplies a power to the DC device 92).

Herein, the aforementioned control unit 70 is configured to receive information of power capacity of each of the power devices 20 as well as information of required current or power from each of the DC devices 92 while the power supply apparatus 10 is in operation. In order to improve power efficiency of a whole system, the control unit 70 is configured to, upon receiving the information, decide amounts of power to be supplied from each of the power devices 20 with reference to electric generating capacities of each of power sources connected respectively to the power devices 20, a remaining battery level, and a period of time. Thereafter, the control unit 70 is configured to adjust outputs of each of the power devices 20 depending on the resultant amounts of power. That is, the control unit 70 is configured to transmit the instruction values prescribing the magnitudes of the output currents Iob, Ioc, and Iod of the second power devices 40 to the adjustment units 64 of the second power devices 40 with consideration for the efficiency of the whole system, respectively. It is noted that the instruction value may be defined as a current value, and that the instruction values may be voltage values depending on the magnitudes of the output currents Iob, Ioc, and Iod, respectively. Further, the instruction values are not limited to the output currents Iob, Ioc, and Iod for each of the second power devices 40, but may be magnitudes of output power of each of the second power devices 40.

The CPU 640 is configured to output the output voltage V6 having its magnitude corresponding to the instruction value received from the control unit 70. The non-inverting amplifier circuit 643 is configured to increase its output voltage V7 as the output voltage V6 of the CPU 640 increases and to decrease its output voltage V7 as the output voltage V6 of the CPU 640 decreases. Therefore, the output voltage V6 has a proportional relation with the output voltage V7.

Further, the current detector 60 has a differential amplifier circuit 606 interposed between the voltage follower 604 and the resistor 605. The differential amplifier circuit 606 is configured to apply a voltage V8 to the switching IC 620. Herein, the voltage V8 is proportionate to a difference voltage (V7−V4) between the output voltage V7 of the non-inverting amplifier circuit 643 and the detection voltage V4 (the output voltage of the voltage follower 604) of the current detector 60, and is defined as V8=β(V7−V4), wherein β>0. Therefore, even if the detection voltage V4 is not changed, the voltage V8 is increased when the output voltage V6 and the output voltage V7 are increased depending on the instruction value from the control unit 70. By contrast, the voltage V8 applied to the switching IC 620 is decreased when the output voltage V6 and the output voltage V7 are decreased. It is noted that β is selected such that the switching IC 620 can make a calculation of the voltage V8 and the detection voltage V5.

The switching IC 620 is configured to output the pulse width modulation signal S2 to the switching device 630. The duty ratio of the pulse width modulation signal S2 is selected (varied) such that a difference voltage Vs (=V8−V5=βV7−(V5+βV4)) between the voltage V8 and the detection voltage V5 is kept constant. In particular, when the difference voltage Vs is increased from a preceding one, the switching IC 620 increases the duty ratio of the pulse width modulation signal S2 to reduce the difference voltage Vs (to the preceding one). By contrast, when the difference voltage Vs is decreased from a preceding one, the switching IC 620 decreases the duty ratio of the pulse width modulation signal S2 to increase the difference voltage Vs (to the preceding one).

For example, the switching device 630 is a field-effect transistor. The switching device 630 has its gate receiving the pulse width modulation signal S2 from the switching IC 620 via a resistor 635. Therefore, the switching device 630 is turned on and off in accordance with the duty ratio of the pulse width modulation signal S2 from the switching controller 62. While the switching device 630 is turned on, the switching device 630 has its source electrically connected to its drain. Thereby, the inductor 632 continues to accumulate electromagnetic energy. Thereafter, when the switching device 630 is turned off, the inductor 632 discharges the accumulated electromagnetic energy. Thereby, the input voltage Vin is raised. The raised input voltage Vin is smoothed by the smoothing capacitor 634 and is output to the DC device 92 (see FIG. 1) as the output voltage Vout.

When the output current Iout (the detection voltage V4) is increased, the different voltage Vs is decreased from a preceding one. In this situation, the switching IC 620 decreases the duty ratio of the pulse width modulation signal S2 to increase the difference voltage Vs to the preceding one. As a result, the output voltage Vout (the detection voltage V5) is decreased. Meanwhile, when the output current Iout (the detection voltage V4) is decreased, the different voltage Vs is increased from a preceding one. In this situation, the switching IC 620 increases the duty ratio of the pulse width modulation signal S2 to decrease the difference voltage Vs to the preceding one. As a result, the output voltage Vout (the detection voltage V5) is increased.

That is, as shown in FIG. 5A, the second power device 40 makes a feedback control to keep the difference voltage Vs constant, thereby having the output current-output voltage characteristics (a characteristics of keeping Vout+aIout constant) of decreasing monotonically (linearly) the output voltage Vout of the second power device 40 with an increase of the output current Iout of the second power device 40.

The line indicative of the output current-output voltage characteristics of the second power device 40 has an intersection point with a line indicative of the output current-output voltage characteristics of the first power device 30. Therefore, when the second power device 40 is used in combination with the first power device 30, the output voltages Vob, Voc, and Vod of the second power devices 40 are coordinated with the output voltage Voa of the first power device 30, respectively (that is, the output voltages Vob, Voc, and Vod of the second power devices 40 become identical to the output voltage Voa of the first power device 30, respectively). Accordingly, the output currents Iob, Ioc, and Iod of the second power devices 40 are corresponding to the output voltages Vob, Voc, and Vod being identical to the output voltage Voa of the first power device 30, respectively.

Herein, when the output currents Iob, Ioc, and Iod decrease, the output voltages Vob, Voc, and Vod vary depending on the output current-output voltage characteristics shown in FIG. 6, thereby temporarily increasing, respectively (see (A) in FIG. 6). As seen from the above, when the output voltages Vob, Voc, and Vod increase, the output currents Iob, Ioc, and Iod increase, respectively. As a result, the detection voltage V4 also increases (see (B) in FIG. 6). The duty ratio of the pulse width modulation signal S2 decreases because the difference voltage Vs decreases as the detection voltage V4 increases. Consequently, the respective output voltages Vob, Voc, and Vod (detection voltage V5) decrease (see (C) in FIG. 6). Thus, the respective output voltages Vob, Voc, and Vod become identical to the output voltage Voa.

Meanwhile, when the output currents Iob, Ioc, and Iod increase, the output voltages Vob, Voc, and Vod vary depending on the output current-output voltage characteristics shown in FIG. 6, thereby temporarily decreasing, respectively (see (D) in FIG. 6). As seen from the above, when the output voltages Vob, Voc, and Vod decrease, the output currents Iob, Ioc, and Iod decrease, respectively. As a result, the detection voltage V4 also decreases (see (E) in FIG. 6). The duty ratio of the pulse width modulation signal S2 increases because the difference voltage Vs increases as the detection voltage V4 decreases. Consequently, the respective output voltages Vob, Voc, and Vod (detection voltage V5) decrease (see (F) in FIG. 6). Thus, the respective output voltages Vob, Voc, and Vod become identical to the output voltage Voa.

The second power devices 40 repeat the aforementioned operation to make the feed back control for keeping the output current Iob, Ioc, and Iod constant, respectively.

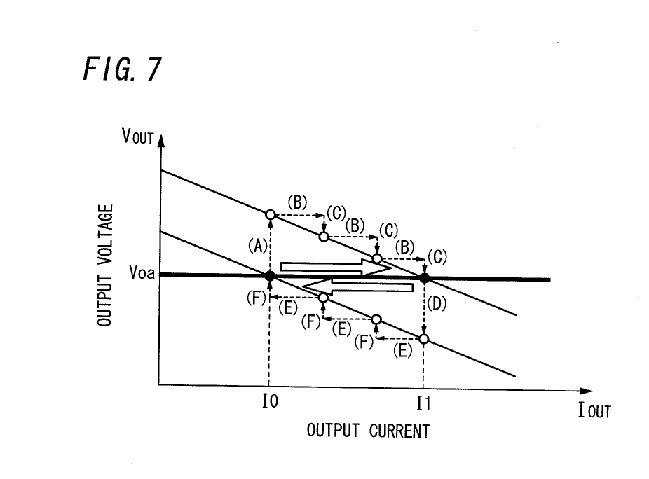

Next, an explanation is made to an adjustment operation by the adjustment unit 64 with reference to FIG. 7.

For example, when a total consumed current (load current) of a side of the DC device 92 increases, the control unit 70 provides to the second power devices 40 the instruction values for increasing the output currents Iob, Ioc, and Iod (that is, the instruction values indicating the targeted output currents Iob, Ioc, and Iod greater than the present output currents Iob, Ioc, and Iod), respectively.

The CPU 640 of the adjustment unit 64 outputs the output voltage V6 corresponding to the instruction value received from the control unit 70. Upon receiving the aforementioned instruction value, the CPU 640 increases the output voltage V6. Consequently, the output voltage V7 also increases, and the voltage V8 (=β(V7−V4)) also increases. In this situation, since the difference voltage Vs (=βV7−(V5+βV4)) increases, the switching controller 620 outputs the pulse width modulation signal S2 having its greater duty ratio. As a result, the output voltages Vob, Voc, and Vod temporarily exceed the output voltage Voa (see (A) in FIG. 7). This operation means adding a predetermined voltage to the output voltage Vob, Voc, or Vod of the second power device 40. The predetermined voltage is selected such that, when the second power device 40 gives the output voltage Vob, Voc, or Vod identical to the output voltage Voa of the first power device 30 under the varied output current-output voltage characteristics, the second power device 40 gives the output current Iob, Ioc, or Iod reaching the output current Iout corresponding to the instruction value. For example, as shown in FIG. 7, when the unadjusted output current is I0 and the adjusted output current (output current corresponding to the instruction value) is I1, the aforementioned predetermined voltage is given by a(I0−I1).

When the output voltages Vob, Voc, and Vod increase by an addition of the predetermined voltage, the output currents Iob, Ioc, and Iod increase, respectively (see (B) in FIG. 7). As a result, the detection voltage V4 increases. In this situation, since the difference voltage Vs decreases, the switching controller 620 outputs the pulse width modulation signal S2 having its lower duty ratio. Consequently, the output voltages Vob, Voc, and Vod decrease (see (C) in FIG. 7).

The second power device 40 repeats this operation. Thereby, the output voltages Vob, Voc, and Vod become identical to the output voltage Voa in due course, respectively. In this situation, the output currents Iob, Ioc, and Iod become identical to the output current Iout according to the instruction value, respectively.

As a result, the adjustment unit 64 makes a translational movement of the line indicative of the output current-output voltage characteristics of the second power device 40 in order to obtain the output current Iob, Ioc, or Iod respectively at intersections with the line indicative of constant voltage characteristics (the output current-output voltage characteristics of the first power device 30), thus obtained output current reaching the output current Iout (I1, in FIG. 7) corresponding to the instruction value.

Even after the output current-output voltage characteristics of the second power device 40 are varied, the output voltages Vob, Voc, and Vod are coordinated with the output voltage Voa of the first power device 30, respectively in a like fashion as the power supply apparatus 10 operates before the output current-output voltage characteristics of the second power device 40 is varied. Therefore, the second power devices 40 output the output currents Iob, Ioc, and Iod at the time when the output voltages Vob, Voc, and Vod are coordinated with the output voltage Voa of the first power device 30, respectively.

Meanwhile, when the total consumed current (load current) of the side of the DC device 92 decreases, the control unit 70 provides to the second power devices 40 the instruction values for decreasing the output currents Iob, Ioc, and Iod (that is, the instruction values indicating the targeted output currents Iob, Ioc, and Iod lower than the present output currents Iob, Ioc, and Iod), respectively.

The CPU 640 of the adjustment unit 64 outputs the output voltage V6 corresponding to the instruction value received from the control unit 70. In the case of the aforementioned instruction value, the CPU 640 decreases the output voltage V6. Consequently, the output voltage V7 also decreases, and the voltage V8 (=β(V7−V4)) also decreases. In this situation, since the difference voltage Vs (=βV7−(V5+βV4)) decreases, the switching controller 620 outputs the pulse width modulation signal S2 having its lower duty ratio. As a result, the output voltages Vob, Voc, and Vod temporarily fall below the output voltage Voa (see (D) in FIG. 7). Thus, the adjustment unit 64 subtracts the predetermined voltage from the output voltage Vob, Voc, or Vod of the second power device 40. This operation means adding a predetermined voltage to the output voltage Vob, Voc, or Vod of the second power device 40. The predetermined voltage is selected such that, when the second power device 40 gives the output voltage Vob, Voc, or Vod identical to the output voltage Voa of the first power device 30 under the varied output current-output voltage characteristics, the second power device 40 gives the output current Iob, Ioc, or Iod reaching the output current Iout corresponding to the instruction value. For example, as shown in FIG. 7, when the unadjusted output current is I0 and the adjusted output current (output current corresponding to the instruction value) is I1, the aforementioned predetermined voltage is given by a(I0−I1).

When the output voltages Vob, Voc, and Vod decrease by a subtraction of the predetermined voltage, the output currents Iob, Ioc, and Iod decrease, respectively (see (E) in FIG. 7). As a result, the detection voltage V4 decreases. In this situation, since the difference voltage Vs increases, the switching controller 620 outputs the pulse width modulation signal S2 having its greater duty ratio. Consequently, the output voltages Vob, Voc, and Vod decrease (see (F) in FIG. 7).

The second power device 40 repeats this operation. Thereby, the output voltages Vob, Voc, and Vod become identical to the output voltage Voa in due course, respectively. In this situation, the output currents Iob, Ioc, and Iod become identical to the output current Iout according to the instruction value, respectively.

As a result, the adjustment unit 64 makes a translational movement of the line indicative of the output current-output voltage characteristics of the second power device 40 in order to obtain the output current Iob, Ioc, or Iod respectively at intersections with the line indicative of constant voltage characteristics (the output current-output voltage characteristics of the first power device 30), thus obtained output current reaching the output current Iout (I1, in FIG. 7) corresponding to the instruction value.

Even after the output current-output voltage characteristics of the second power device 40 are varied, the output voltages Vob, Voc, and Vod are coordinated with the output voltage Voa of the first power device 30, respectively in a like fashion as the power supply apparatus 10 operates before the output current-output voltage characteristics of the second power device 40 is varied. Therefore, the second power devices 40 output the output currents Iob, Ioc, and Iod at the time when the output voltages Vob, Voc, and Vod are coordinated with the output voltage Voa of the first power device 30, respectively.

As seen from the above, the adjustment unit 64 is configured to, when varying the output current-output voltage characteristics, adjust the output voltages Vob, Voc, and Vod, of the second power device 40 to match a voltage obtained by adding a predetermined voltage to or subtracting the same from the unadjusted output voltages Vob, Voc, and Vod of the second power device 40 such that the output currents Iob, Ioc, and Iod of the second power device 40 are corresponding to the instruction value while the output voltages Vob, Voc, and Vod of the second power devices 40 are identical to the output voltage Voa of the first power device 30 concerning the varied output current-output voltage characteristics.

As described in the above with reference to the present embodiment, each of the second devices 40 can, in response to a varying load current, vary its output current-output voltage characteristics on the basis of the instruction value received from the control unit 70, as shown in FIG. 7. Even after the output current-output voltage characteristics are varied, the second power devices 40 provides their output voltages Vob, Voc, and Vod all identical to the output voltage Voa of the first power device 30. Therefore, the second power devices 40 provide their output currents Iob, Ioc, and Iod which are in correspondence to the output voltages Vob, Voc, and Vod, and are all identical to the output voltage Voa of the first power device 30. Consequently, even if the load current is varied, the power supply apparatus 10 can select the magnitudes of the output currents Iob, Ioc, and Iod for each of the second power devices 40 in match with the load current, respectively. In addition, the output voltages Vob, Voc, and Vod can be kept constant because the second power devices 40 have their output voltages Vob, Voc, and Vod kept identical to the output voltage Voa of the first power device 30 even if the load current changes its magnitude. As a result, it is possible to make stable power supply for the DC device 92.

Following shows an instance. FIG. 5A shows the output current-output voltage characteristics of the second power device 40, and FIG. 5B shows the output current-output voltage characteristics of the first power device 30. When the second power device 40 receives the instruction value corresponding to the output current I₁₁ from the control unit 70 while the output current Iout is I₁₂, the line indicative of the output current-output voltage characteristics of the second power device 40 is translated as indicated by an arrow in FIG. 5C. As a result, the output current Iout of the second power device 40 is increased from I₁₂ to I₁₁.

Additionally, in the present embodiment, the first power device 30 receives the source voltage from the commercial power source 81 supplying stable power. Therefore, it is possible to reduce an influence of a load variation caused by an on-off operation of the DC device 92. Thus, it is possible to make more stable power supply for the DC device 92. By contrast, when the first power device 30 is connected to the solar cell 82, the power supply for the DC device 92 becomes unstable due to solar insolation. When the first power device 30 is connected to the secondary cell 83, the power supply for the DC device 92 becomes unstable due to a charging status of the secondary cell 83.

By the way, most parts of the first power device 30 is common to the second power device 40. Therefore, the second power device 40 can be manufactured by sharing most parts of the first power device 30 only with exception of few additional parts. Therefore, the second power device 40 can be implemented only by slight modification to the configuration of the first power device 30.

Moreover, when a voltage drop caused by a wire (DC supply line 93) is not negligible, the first power device 30 may be configured to preliminarily increase its output voltage Voa to supplement the voltage drop. With this modification, the output voltages Vob, Voc, and Vod of the second power devices 40 are also increased depending on the output voltage Voa of the first power device 30. Therefore, it is possible to adjust a voltage applied to the DC device 92 to a proper voltage. This modification can be applied to following second to ninth embodiments.

### Second Embodiment

By the way, the second power devices 40 of the first embodiment adjust its output currents Iob, Ioc, and Iod by translating the line indicative of the output current-output voltage characteristics, respectively.

However, if an error occurs due to a variation of the output voltage Voa of the first power device 30, or if a conversion error occurs at the time of converting the instruction value of the control unit 70 into the output voltage V6, the second power devices 40 provide the actual output currents Iob, Ioc, and Iod which may not reach the output current Iout corresponding to the instruction value of the control unit 70.

Therefore, it is desired to improve an accuracy of the output currents Iob, Ioc, and Iod of the second power devices 40 (reduce an error between the actual output current and the output current corresponding to the instruction value).

In view of the above, the second power devices 40A of the power supply apparatus 10A of the present embodiment have a function of reducing an error between the output currents Iob, Ioc, and Iod detected by the current detector 60 and the output current Iout corresponding to the instruction value of the control unit 70.

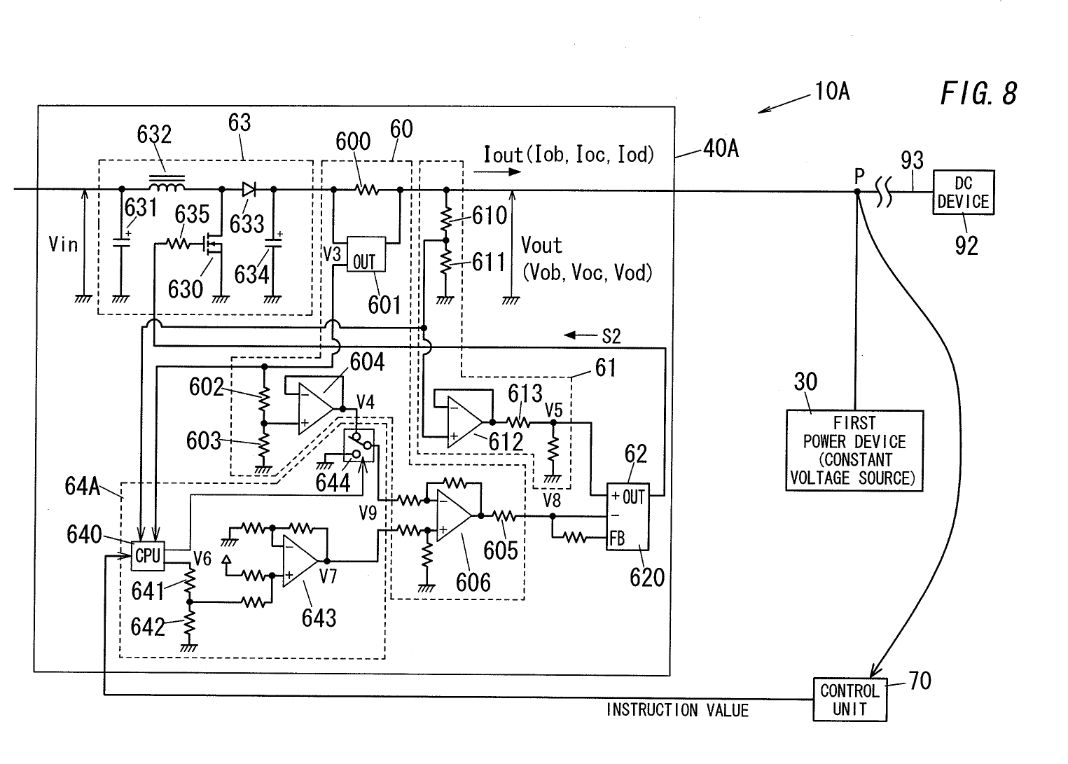

As shown in FIG. 8, in the adjustment unit 64A of the present embodiment, the CPU 640 is configured to obtain a detection result (detection voltage V3) of the current detector 60 and a detection result of the voltage detector 61. Upon receiving the detection voltage V3, the CPU 640 is configured to calculate the error between the actual output current Iout and the output current Iout corresponding to the instruction value on the basis of the detection voltage V3 and the instruction value of the control unit 70. For example, in the case of the instruction value of the control unit 70 being a current value, the CPU 640 converts the magnitude of the detection voltage V3 to a current value, and calculates the error between the converted current value and the instruction value of the control unit 70.

Upon calculating the error, the CPU 640 adjusts the output voltage V6 to reduce the calculated error. Thus, the output current-output voltage characteristics of the second power device are corrected. That is, the adjustment unit 64A is configured to correct the output current-output voltage characteristics such that the output currents Iob, Ioc, and Iod detected by the current detector 60 become identical to the output current Iout corresponding to the instruction value.

The power supply apparatus 10A of the present embodiment feeds back the actual output currents Iob, Ioc, and Iod, and corrects the error between the actual output currents Iob, Ioc, and Iod and the output current Iout corresponding to the instruction value. Therefore, it is possible to improve the accuracy of the output current Iout of the second power device 40A.

### Third Embodiment

By the way, the second power device 40 of the power supply apparatus 10 of the first embodiment has its output current-output voltage characteristics of decreasing monotonically the output voltage Vout of the second power device 40 with an increase of the output current Iout of the second power device 40. Conversely, the second power device 40 has its output voltage Vout increased monotonically as its output current Iout decreases. Therefore, when the output currents Iob, Ioc, and Iod is decreased as the load current decreases, the output voltages Vob, Voc, and Vod become high. Thereby, a relatively high voltage is likely to be applied to the DC device 92.

In view of the above, the power supply apparatus 10 of the present embodiment is configured to vary the output current-output voltage characteristics (inclination control characteristics) of the second power device 40 such that the output voltages Vob to Voc do not exceed a predetermined threshold. Additionally, a basic configuration of the power supply apparatus 10 of the present embodiment 10 is common to the power supply apparatus of the first embodiment. Therefore, the drawings used for an explanation of the power supply apparatus 10 of the first embodiment are also used for explanation of the power supply apparatus 10 of the present embodiment.

In the power supply apparatus 10 of the present embodiment, the adjustment unit 64 is configured to modify the output current-output voltage characteristics of the second power device 40, and the control unit 70 is configured to instruct the adjustment unit 64 to modify the output current-output voltage characteristics of the second power device 40.

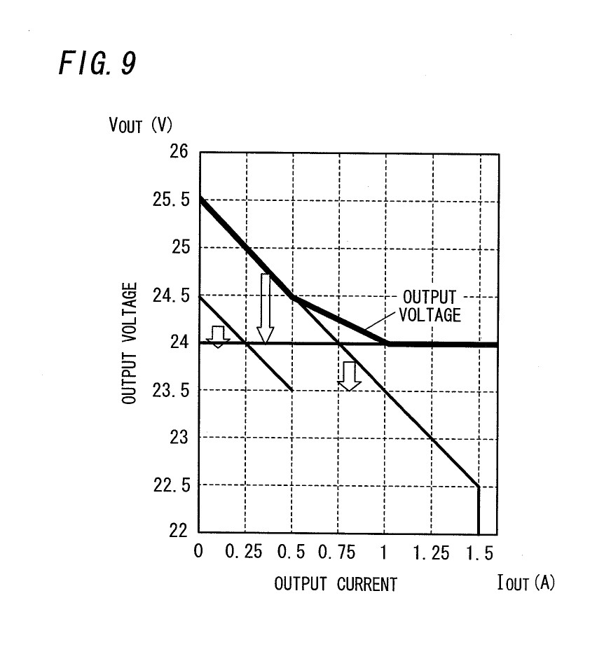

For example, it is assumed that the output voltage Vout (Vob, Voc, Vod) of the second power device 40 exceeds the output voltage Vout (Voa) of the first power device 30 due to a decrease of the output current Iout (Iob, Ioc, Iod) of the second power device 40. In this situation, as shown in FIG. 9, the power supply apparatus of the present embodiment modifies the output current-output voltage characteristics of the second power device 40 such that the output voltages Vout (Vob, Voc, Vod) of the second power device 40 becomes identical to the output voltage Vout (Voa) of the first power device 30.

The control unit 70 of the present embodiment is configured to monitor a voltage (output voltage of the power supply apparatus) of a power source connection point P. The control unit 70 is configured to send a configuration output voltage instruction to the second power device 40 such that the output voltages Vob to Vod of the second power devices 40 become identical to the output voltage Voa when the voltage of the power source connection point P exceeds the output voltage Voa of the first power device 30.

Upon receiving the configuration output voltage instruction, the adjustment unit 64 of the present embodiment is configured to vary the output current-output voltage characteristics while deceasing the output voltage Vout monotonically with the increase of the output current Iout in order to provide the output voltage Vout which is associated with the output current Iout being supplied to the DC device, and which becomes equal to the output voltage Voa of the first power device 30.

According to the power supply apparatus 10 of the present embodiment, it is possible to restrain an increase of the output voltage Vout (Vob, Voc, Vod) of the second power device 40 even if the load current decreases its magnitude. Therefore, it is possible to restrain the DC device 92 from receiving the high voltage.

### Fourth Embodiment

The power supply device 10 of the third embodiment varies the output current-output voltage characteristics of the second power device 40 when the load current immediately becomes low, thereby preventing the DC device 92 from receiving the high voltage. However, in the power supply apparatus 10 of the third embodiment, the output voltages Vob, Voc, and Vod is likely to temporally increase prior to completion of variation of the output current-output voltage characteristics. Thereby the high voltage is likely to be applied to the DC device 92.

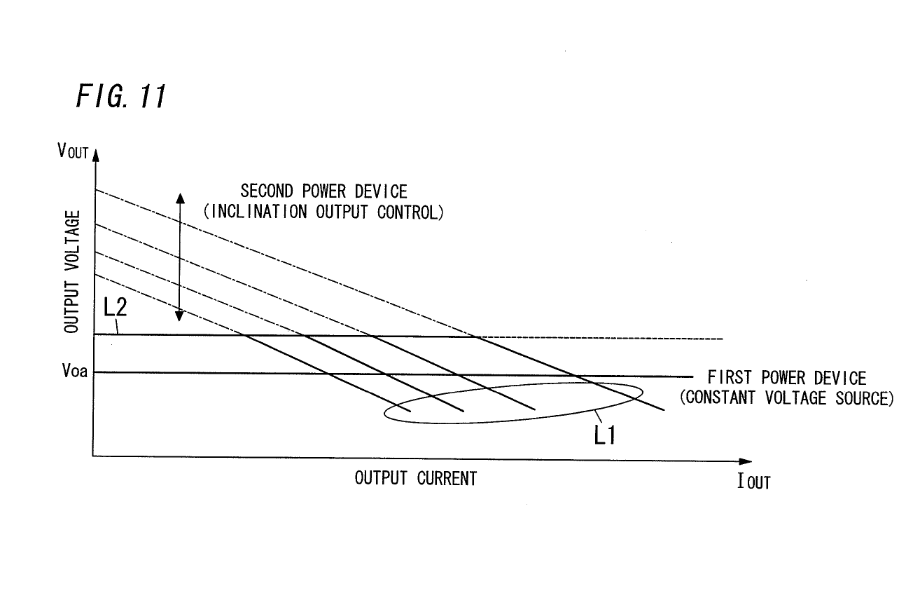

In view of the above, in the power supply apparatus 10B of the present embodiment, as shown in FIG. 11, the adjustment unit 64B of the second power device 40 is configured to vary the output current-output voltage characteristics such that the output current-output voltage characteristics of the second power device 40 become the constant voltage characteristics (that is, the output current-output voltage characteristics of keeping the output voltage of the second power device constant irrespective of a magnitude of the output current of the second power device 40).

Consequently, the second power device 40B has the output current-output voltage characteristics (hereinafter referred to as “first output characteristics”, in the present embodiment) L1 of decreasing monotonically the output voltage of the second power device 40B with an increase of the output current of the second power device 40B, and the output current-output voltage characteristics (hereinafter referred to as “second output characteristics”, in the present embodiment) L2 of keeping the output voltage of the second power device 40B constant irrespective of a magnitude of the output current of the second power device 40B. The first output characteristics L1 represent the output current—output voltage characteristics to reflect a situation where the output voltage Vout is in a relatively low range and the output current Iout is in a relatively high range. The second output characteristics L2 represent the same to reflect a situation where the output current Iout is in a relatively low range. Components which are common to the power supply apparatus 10 of the present embodiment and the power supply apparatus 10 of the first embodiment are indicated with the same reference numerals as the first embodiment, and no explanation thereof is deemed necessary.

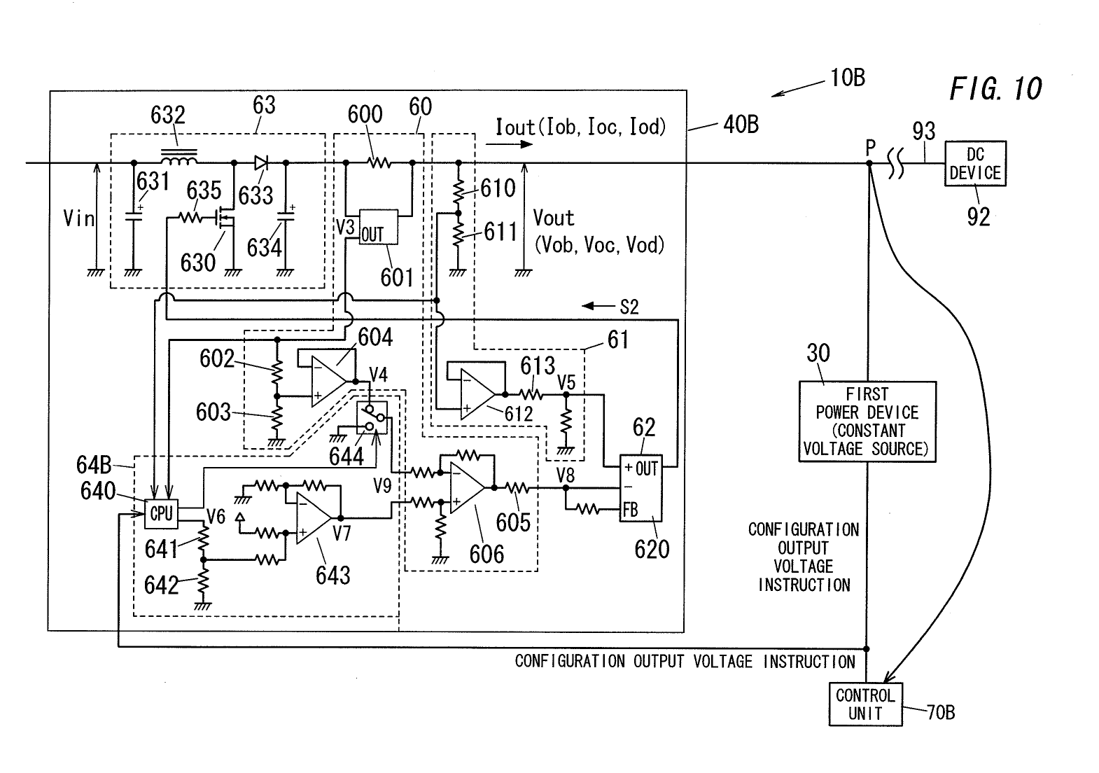

As shown in FIG. 10, the adjustment unit 64B includes a selection switch 644 to switch between the first output characteristics L1 and the second output characteristics L2.

The selection switch 644 is configured to switch a destination of the non-inverting input terminal of the differential amplifier circuit 604 between an output terminal (voltage follower 604 side) of the voltage follower 604 and a ground (ground side). That is, in the power supply apparatus 10B of the present embodiment, the differential amplifier circuit 606 has its input voltage V9 selected from the detection voltage V4 and 0V.

When the selection switch 644 is switched from the ground side to the voltage follower 604 side, the input voltage V9 becomes the detection voltage V4 indicative of the magnitude of the output current Iob, Ioc, or Iod. As a result, the output current-output voltage characteristics of the second power device 40B become the first output characteristics L1. When the selection switch 644 is switched to the ground side from the voltage follower 604 side, the input voltage V9 becomes constant irrespective of the magnitude of the output current Iout. Therefore, the output current-output voltage characteristics of the second power device 40B become the second output characteristics L2.

The selection switch 644 is controlled by the CPU 640. The CPU 640 is configured to control the selection switch 644 on the basis of a comparison result of the output voltages Vob, Voc, and Vod and a prescribed threshold (the output voltages Vob, Voc, and Vod of the second output characteristics L2, in the present embodiment). The CPU 640 of the present embodiment keeps the selection switch 644 switched to the voltage follower 604 side while the output voltages Vob, Voc, and Vod are less than the prescribed threshold. By contrast, the CPU 640 of the present embodiment switches the selection switch 644 to the ground side from the voltage follower 604 side when the output voltages Vob, Voc, and Vod become identical to the prescribed threshold. The output voltages Vob to Vod of the second output characteristics L2 are selected to be a trouble-free voltage in view of the source voltage of the DC device 92.

As seen from the above, the adjustment unit 64B is configured to switch the output current-output voltage characteristics from the first output characteristics L1 to the second output characteristics L2 when the output voltage Vout becomes identical to the prescribed threshold.

Therefore, the power supply apparatus 10B of the present embodiment can restrain the surges of the output voltages Vob, Voc, and Vod of the second power devices 40B when the load current decreases suddenly. Therefore, the voltage applied to the DC voltage 92 can be restrained from excessively increasing.

In addition, the output voltages Vob, Voc, and Vod of the second characteristics L2 are slightly higher than the output voltage Voa of the first power device 30. Consequently, it is possible to reduce a voltage rise even if the output currents Iob, Ioc, and Iod as the load current decreases. Therefore, it is possible to restrain the DC device 92 from receiving a high voltage.

Moreover, in the power supply apparatus 10B of the present embodiment, although the second output characteristics L2 are the constant voltage characteristics, the second output characteristics L2 may be the output current-output voltage characteristics having its gradient smaller than that of the first output characteristics L1. That is, the adjustment unit 64B may be configured to modify the output current-output voltage characteristics of the second power device 40B to reduce an increase rate of the output voltage Vout relative to a decrease of the output current Iout when the output voltage Vout of the second power device 20 reaches the predetermined threshold.

### Fifth Embodiment

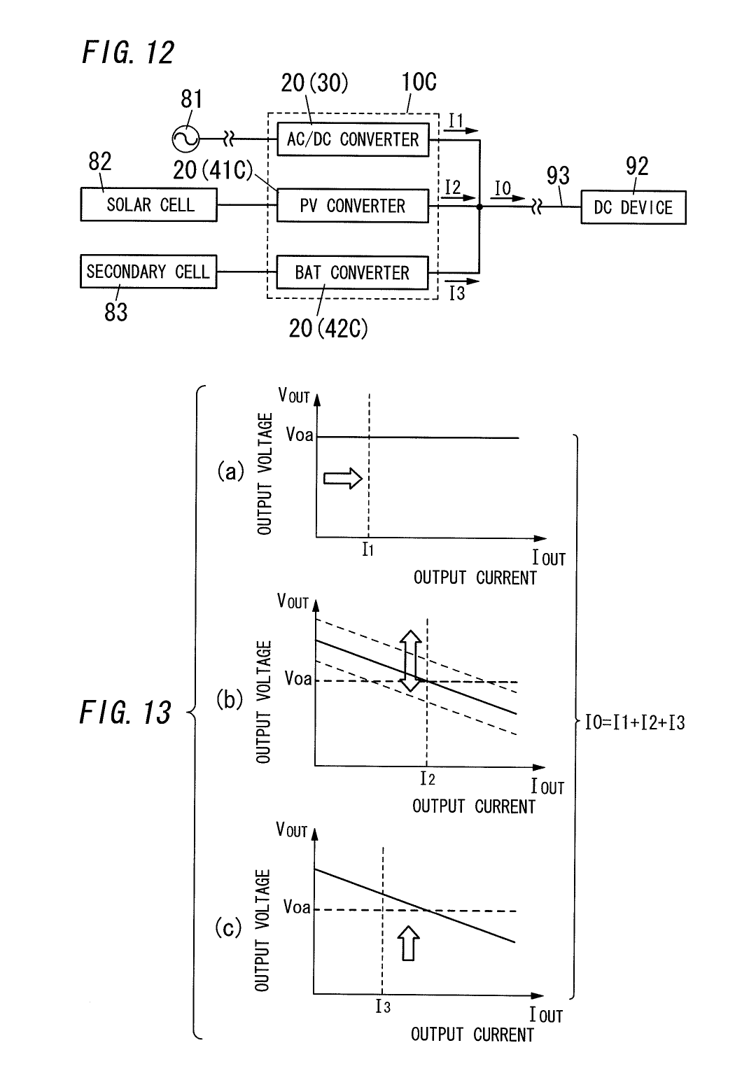

The power supply apparatus 10C of the present embodiment is configured to make efficient use of the solar cell 82. As shown in FIG. 12, the power supply apparatus 10C includes the first power device (hereinafter referred to as “AC/DC converter”, in the present embodiment) 30 to be connected to the commercial power source 81. In addition, the power supply apparatus 10C includes the second power device (hereinafter referred to as “PV converter”, in the present embodiment) 41C to be connected to the solar cell 82 and the second power device (hereinafter referred to as “BAT converter”, in the present embodiment) 42C to be connected to the secondary cell 83.

The PV converter 41C has its configuration similar to the second power device 41 of the first embodiment. In addition, the PV converter 41C is configured to adjust its output current Iout such that an output power of the solar cell 82 reaches its maximum in an available supply range where the solar cell 82 is able to supply an electric power. In this situation, the output current Iout can be calculated by use of current-voltage characteristics of the solar cell 82 and the output voltage of the AC/DC converter 30. In a following explanation, it is assumed that the output current Iout at the time that the output power of the solar cell 82 attains its maximum in the available supply range has its current value of I2.

Further, the output current Iout of the PV converter 41C is adjusted by varying the output current-output voltage characteristics. The PV converter 41C varies its output current-output voltage characteristics (see FIG. 13 (b)) such that an output power of the solar cell 82 reaches its maximum in the available supply range of the solar cell 82. A modification of the output current-output voltage characteristics of the PV converter 41C is realized by use of the aforementioned adjustment unit 64. According to the aforementioned operation, the PV converter 41C supplies its output current Iout having its current value of I2 to the DC device 92.

Moreover, the PV converter 41C is configured to charge the secondary cell 83 by use of an excess of its output current Iout when its output current Iout exceeds the load current (it is assumed that the current value of the load current is I0), that is, I2>I0.

The BAT converter 42C has its configuration similar to the second power device 42 of the first embodiment. In addition, the BAT converter 42C is configured to operate while the load current exceeds the output current Iout of the PV converter 41C (that is, I0>I2). In this situation, the BAT converter 42C is configured to provide the output current Iout which has its current value I3 (=I0−I2) to supplement a shortage of the load current. The output current Iout of the BAT converter 42C is adjusted by modifying the output current-output voltage characteristics. As shown in FIG. 13 (c), when the load current I0 exceeds the output current I2 of the PV converter 41C, the BAT converter 42C varies its output current-output voltage characteristics under the condition where the output voltage Vout decreases monotonically as the output current Iout increases, thereby providing the output current Iout having its current value of I3 to supplement the shortage of the load current. A modification of the output current-output voltage characteristics of the BAT converter 42C is realized by use of the aforementioned adjustment unit 64. According to the aforementioned operation, the BAT converter 42C supplies its output current Iout having its current value of I3 (=I0−I2) to the DC device 92.

The BAT converter 42C has an upper limit of the output current Iout. Therefore, when the load current increases (that is, the case of I0>I2+I3), the BAT converter 42C may fail to supplement the shortage even when the output current Iout is its maximum.

In this situation, the AC/DC converter 30 supplies an electrical power to the DC device 92. More particularly, as shown in FIG. 13 (a), the AC/DC converter 30 supplies the output current Iout having its current value I1 (=I0−I2−I3) to the DC device 92.

The power supply apparatus 10C of the present embodiment supplies the output current Iout of the PV converter 41C to the DC device 92 and charges the secondary cell 83 with the output current Iout, thereby enabling efficient use of the solar cell 82. In addition, since the AC/DC converter 30 operates to provide a minimum output current Iout, it is possible to reduce the commercial power source 81 as much as possible, thereby accomplishing energy saving.

Moreover, although the load current I0 is kept constant, the output current-output voltage characteristics may be changed in accordance with a supply capacity of the power source (e.g. the solar cell 82) to be connected to the second power device 40. For example, when the supply capacity of the solar cell 82 becomes low, the AC/DC converter 30, the PV converter 41C, and the BAT converter 42C may be made to alter the individual output current-output voltage characteristics in such a manner as to render the output current Iout of the PV converter 41C less than the current value I2, to render the output current Iout of the BAT converter 42 greater than the current value I3 by an extent of the decreased current value I2, or to render the output current Iout of the AC/DC converter 30 greater than the current value I1.

### (Sixth Embodiment

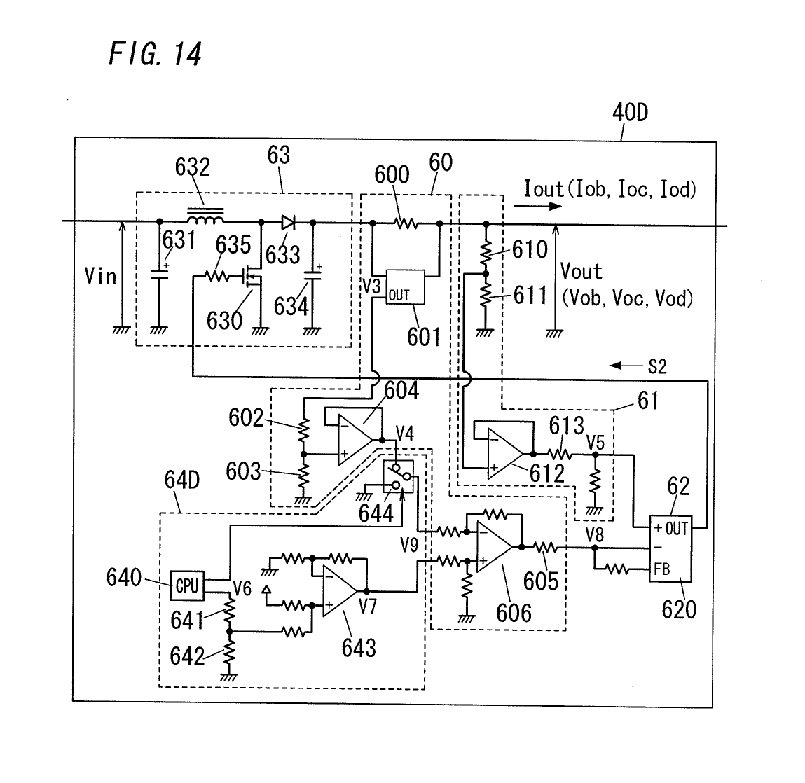

As shown in FIG. 14, the power supply apparatus 10D of the present embodiment is different from that of the first embodiment (see FIG. 4) in that each of the second power devices 40D have their adjustment unit 64D provided with the selection switch 644. Components which are common to the power supply apparatus 10D of the present embodiment and the power supply apparatus 10 of the first embodiment are indicated with the same reference numerals as the first embodiment, and no explanation thereof is deemed necessary.

The selection switch 644 is used for switching between a variable voltage mode and a constant voltage mode. Herein, the variable voltage mode is a mode where the output voltage Vout (Vob, Voc, Vod) is a DC voltage which decreases monotonically as the output current Iout (Iob, Ioc, Iod) increases. The constant voltage mode is a mode where the output voltage Vout (Vob, Voc, Vod) is kept constant irrespective of the magnitude of the output current Iout (Iob, Ioc, Iod). It is noted that the output voltages Vob, Voc, and Vod of the constant voltage mode may be identical to the output voltage Voa of the first power device 30. Consequently, even if a device having a constant output voltage Vout is switched from the first power device 30 to the second power device 40D, no change is seen in the supplied voltage to the DC device 92. Therefore, it is possible to successfully supply an electric power to the DC device 92.

The selection switch 644 is configured to switch the destination of the non-inverting input terminal of the differential amplifier circuit 604 between the output terminal (voltage follower 604 side) of the voltage follower 604 and the ground (ground side). That is, in the present embodiment, the differential amplifier circuit 606 has its input voltage V9 selected from the detection voltage V4 and 0V.

When the selection switch 644 is switched from the ground side to the voltage follower 604 side, the input voltage V9 becomes the detection voltage V4 indicative of the magnitude of the output current Iob, Ioc, or Iod. As a result, the second power device 40D is switched from the constant voltage mode to the variable voltage mode. In this situation, the output current-output voltage characteristics of the second power device 40D become the same characteristics as that of the second power device 40 of the first embodiment. By contrast, when the selection switch 644 is switched to the ground side from the voltage follower 604 side, the input voltage V9 becomes constant irrespective of the magnitude of the output current Iout. Therefore, the second power device 40D is switched from the variable voltage mode to the constant voltage mode. In this situation, the output current-output voltage characteristics of the second power device 40D become the same characteristics as that of the first power device 30 of the first embodiment. In addition, the output voltages Vob, Voc, and Vod of the second power device 40D at the constant voltage mode are identical to the output voltage Voa of the first power device 30. Therefore, it is possible to successfully supply an electric power to the DC device 92.

The selection switch 644 is controlled by the CPU 640. In other words, the CPU 640 and the selection switch 644 constitute a switching unit configured to switch an operation mode of the second power device 40D between the constant voltage mode and the variable voltage mode.

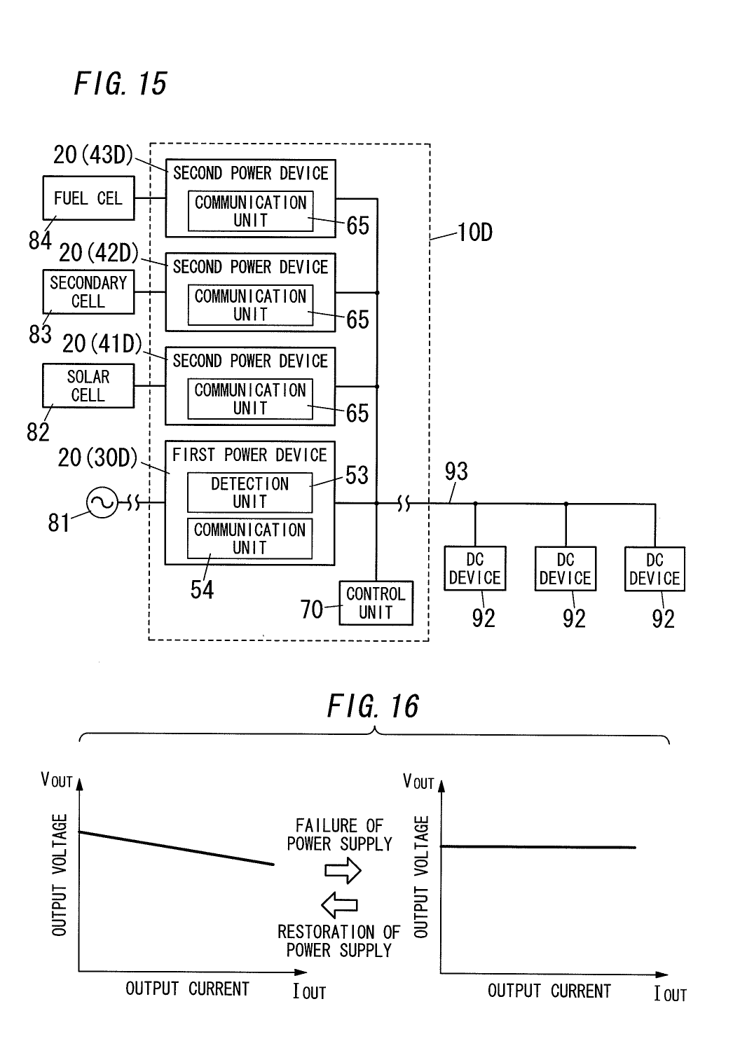

As shown in FIG. 15, the first power device 30D includes a detection unit 53 configured to detect a failure or a restoration of power supply of the commercial power source 81, and a communication unit 54 configured to communicate with the second power device 40D and the control unit 70. The communication unit 54 is a transmitting means configured to transmit a detection result (e.g. a failure detection result and a restoration detection result) of the detection unit 53 to the second power device 40D.

The second power device 40D includes a communication unit 65 configured to communicate with the first power device 30D, the other second power devices 40D, and the control unit 70, in addition to the selection switch 644. The communication unit 65 is a receiving means configured to receive a signal from an external device. Further, the second power devices 40D are preliminary determined to have an order (rank) of being switched from the variable voltage mode to the constant voltage mode.

Next, an explanation is made to an operation of the power supply apparatus 10D of the present embodiment. In order to maintain a power supplied to the DC device 92 as a consequence of the first power device 30D detecting the failure of power supply of the commercial power source 81, the communication unit 54 of the first power device 30D sends the failure detection result (failure detection signal) to the second power device 40D (e.g. the second power device 43D, in this situation) having the highest rank. In the second power device 43D, when the communication unit 65 receives the failure detection signal from the first power device 30D, the CPU 640 switches the selection switch 644 to the ground side. Thereby, the second power device 43D is switched from the variable voltage mode to the constant voltage mode.

As seen from the above, the second power device 43D makes the constant voltage control, thereby keeping its output voltage Vout constant. Therefore, in a like manner as the first power device 30D supplies an electrical power to the DC device 92, it is possible to successfully make power supply to the DC device 92.

Meanwhile, when the first power device 30D detects the restoration of power supply of the commercial power source 81, the communication unit 54 of the first power device 30D sends the restoration detection result (restoration detection signal) to the second power device 43D. In the second power device 43D, when the communication unit 65 receives the restoration detection signal from the first power device 30D, the CPU 640 switches the selection switch 644 to the voltage follower 604 side. Thereby, the second power device 43D is switched from the constant voltage mode to the variable voltage device.

As described in the above, in the power supply apparatus 10D of the present embodiment, when the commercial power source 81 connected to the first power device 30D breaks down or is restored, the output current-output voltage characteristics of the second power device 43D are switched, as shown in FIG. 16.

As seen from the above, according to the power supply apparatus 10D of the present embodiment, when the commercial power source 81 connected to the first power device 30D making the constant voltage control breaks down, the second power device 43D is switched to the constant voltage mode from the variable voltage mode. In this situation, the second power device 43D makes the constant voltage control, thereby keeping its output voltage Vout constant. That is, since the second power device 43D substitutes for the first power source 30D, in a like manner as the first power device 30D supplies an electrical power to the DC device 92, it is possible to successfully make power supply to the DC device 92.

When the commercial power source 81 is restored after its blackout, the second power device 43D is switched to the variable voltage mode from the constant voltage mode, thereby returning to its previous status before the commercial power source 81 breaks down. Therefore, the first power device 30D can supply the constant voltage again. It is possible to make stable power supply because the commercial power source 81 connected to the first power device 30 is a power source which provides stable power relative to the solar cell 82, the secondary cell 83, and the fuel cell 84 connected to the second power device 40D.

In the power supply apparatus 10D of the present embodiment, the second power device 43D is switched to the constant voltage mode from the variable voltage mode when the commercial power source 81 connected to the first power device 30D breaks down. However, either the second power device 41D or 42D may be switched to the constant voltage mode from the variable voltage mode instead of the second power device 43D. In brief, it is sufficient that any one of the second power devices 40D is switched to the constant voltage mode from the variable voltage mode.

In the power supply apparatus 10D of the present embodiment, the first power device 30D directly sends the failure detection signal and the restoration detection signal to the second power device 43D having the highest rank. However, the first power device 30D may send the failure detection signal and the restoration detection signal to the control unit 70, and the control unit 70 may send the received failure detection signal and the received restoration detection signal to the second power device 43D.

In the power supply apparatus 10D of the present embodiment, all the second power devices 40D include the selection switch 644 and the communication unit 65. However, all the second power devices 40D do not need to include the selection switch 644 and the communication unit 65. In other words, the second power devices 40D having the selection switch 644 and the communication unit 65 may be preliminary determined to have the order (rank) of being switched from the variable voltage mode to the constant voltage mode.

### Seventh Embodiment

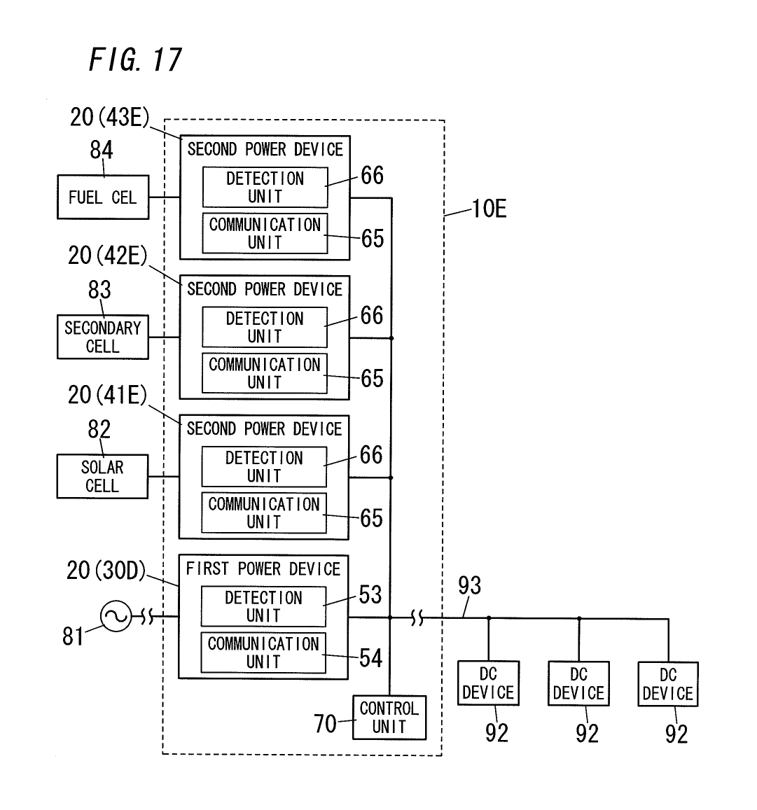

As shown in FIG. 17, the power supply apparatus 10E of the present embodiment is different from the power supply apparatus 10D of the sixth embodiment in that each of the second power devices 40E includes a detection unit 66. Besides, like the sixth embodiment, the power supply apparatus 10E is configured to preliminary determine the order (rank) of the second power devices 40E being switched from the variable voltage mode to the constant voltage mode. Further, components which are common to the power supply apparatus 10E of the present embodiment and the power supply apparatus 10D of the sixth embodiment are indicated with the same reference numerals as the sixth embodiment, and no explanation thereof is deemed necessary.

The detection unit 66 is configured to detect an amount of available electrical power of a power source connected to the second power device 40E. That is, the detection unit 66 of the second power device 41E detects an amount of available electrical power of the solar cell 82, and the detection unit 66 of the second power device 42E detects an amount of available electrical power of the secondary cell 83, and the detection unit 66 of the second power device 43E detects an amount of available electrical power of the fuel cell 84.

In the second power device 40E, the communication unit 65 is defined as a second transmitting means configured to transmit an available amount detection result of the detection unit 66 to the other second power devices 40E.

Next, an explanation is made to an operation of the power supply apparatus 10E of the present embodiment. First, it is assumed that the commercial power source 81 breaks down, and that therefore the second power device 43E is switched from the variable voltage mode to the constant voltage mode in a like manner as the sixth embodiment. In this situation, when the detection unit 66 detects the amount of available electrical power being not greater than a threshold, the second power device 43E sends the available amount detection result to the other second power devices 41E and 42E by the communication unit 65.

Concerning the other second power devices 41E and 42E, at the second power device 40E (e.g. the second power device 42E, in this situation) having its rank next to the second power device 43E, when the communication unit 65 receives the available amount detection result of the second power device 43E, the CPU 640 switches the selection switch 644 to the ground side. Consequently, the second power device 42E having its rank next to the second power device 43E is switched from the variable voltage mode to the constant voltage mode. By contrast, the second power device 41E keeps the variable voltage mode even if the communication unit 65 receives the available amount detection result of the second power device 43E because the second power device 41E has its rank not next to the second power device 43E.

As seen from the above, according to the power supply apparatus 10E of the present embodiment, the second power device 43E having the highest rank is switched to the constant voltage mode from the variable voltage mode when the commercial power source 81 connected to the first power device 30D breaks down. Thereby, the second power device 43E keeps its output voltage Vout constant (a voltage identical to the output voltage Voa of the first power device 30D). In other words, the second power device 43E substitutes for the first power device 30D. Further, in this situation, when the power source (fuel cell 84) connected to the second power device 43E has its amount of available electrical power decreased, the second power device 42E having its rank next to the second power device 43E is switched to the constant voltage mode from the variable voltage mode. Thereby, the second power device 42E keeps its output voltage Vout constant (a voltage identical to the output voltage Voa of the first power device 30D). In other words, the second power device 42E substitutes for the first power device 30D.

Therefore, even if the commercial power source 81 breaks down, in a like manner as the first power device 30D supplies an electrical power to the DC device 92, the power supply apparatus 10E can make stable power supply to the DC device 92.

In the aforementioned instance, the second power device 43E directly sends the available amount detection result to the second power device 42E having its rank next to the second power device 43E. However, the second power device 43E may send the available amount detection result to the control unit 70, and the control unit 70 may send the received available amount detection result to the second power device 42E.

In the power supply apparatus 10E of the present embodiment, all the second power devices 40E include the selection switch 644 and the communication unit 65. However, all the second power devices 40E do not need to include the selection switch 644 and the communication unit 65. In other words, the second power devices 40E having the selection switch 644 and the communication unit 65 may be preliminary determined to have the order (rank) of being switched from the variable voltage mode to the constant voltage mode.

### Eighth Embodiment

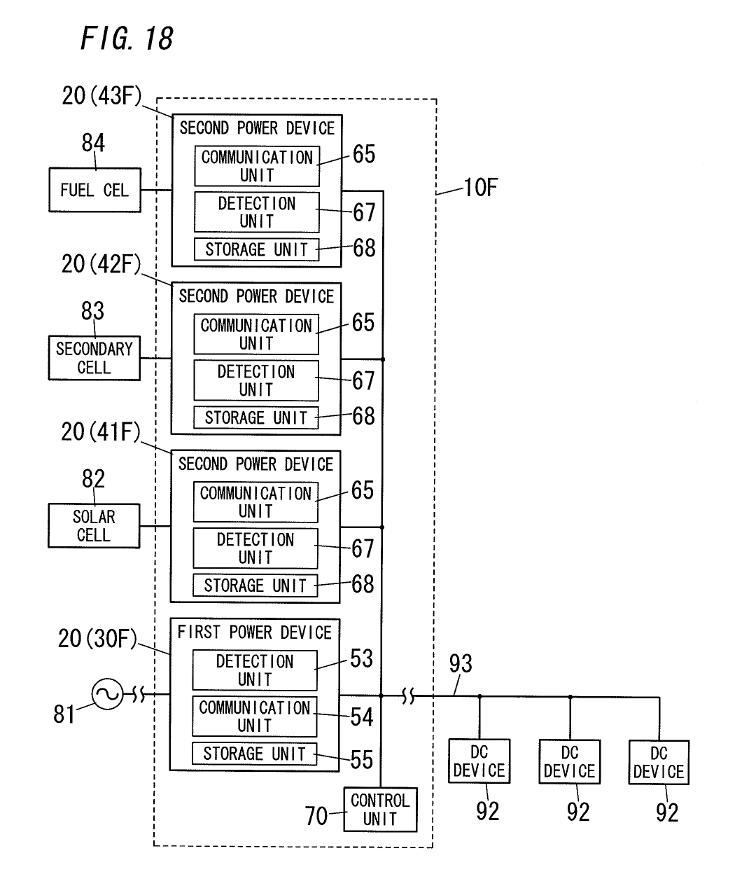

As shown in FIG. 18, the power supply apparatus 10F is different from the power supply apparatus 10E of the seventh embodiment in configurations of the first power device 30F and the second power devices 40F.

The first power device 30F includes a storage unit 55. The first power device 30F is configured to collect information of the amount of available electrical power from all the second power devices 40F and store the collected information in the storage unit 55. Components which are common to the power supply apparatus 10F of the present embodiment and the power supply apparatus 10E of the seventh embodiment are indicated with the same reference numerals as the seventh embodiment, and no explanation thereof is deemed necessary.

The second power device 40F includes a detection unit 67 and a storage unit 68. The detection unit 67 is configured to detect an amount of available electrical power of a power source (that is, the solar cell 82 in the case of the second power device 41F, the secondary cell 83 in the case of the second power device 42F, the fuel cell 84 in the case of the second power device 43F) which is connected thereto. The communication unit 65 sends the information of the amount of available electric power detected by the detection unit 67 to the first power device 30F. Further, the second power device 40F is configured to obtain the information of the amount of available electric power from all the power devices 20 and store the obtained information in the storage unit 68.

Next, an explanation is made to an operation of the power supply apparatus 10F of the present embodiment. When the communication unit 54 receives the information of the amount of available electric power from all the second power devices 40F, the first power device 30F stores the received information of the amount of available electric power in the storage unit 55. Thereafter, when the detection unit 53 of the first power device 30F detects the failure of power supply of the commercial power source 81, the first power device 30F controls the communication unit 54 to send the failure detection result of the detection unit 53 to the second power device 40F. Herein, the second power device 40F as a destination of the failure detection result is selected by use of the information of the amount of available electric power stored in the storage unit 55. In more detail, the first power device 30F refers to the information of the amount of available electric power stored in the storage unit 55 so as to select the second power device 40F (e.g. the second power device 42F, in this situation) affording the largest amount of available electric power from the second power devices 40F as the destination one to which the failure detection result is transmitted.

When the communication unit 65 of the second power device 42F receives the failure detection result, the CPU 640 of the second power device 42F switches the selection switch 644 to the ground side. Thereby, the second power device 42F is switched to the constant voltage mode from the variable voltage mode.

Thereafter, the second power device 42F substitutes for the first power device 30F. Subsequently, when the amount of available electric power of the secondary cell 83 falls below the threshold, the second power device 42F controls the communication unit 65 to send the available amount detection result of the detection unit 66 to the other second power device 40F. Herein, the second power device 40F as a destination of the available amount detection result is selected by use of the information of the amount of available electric power stored in the storage unit 68. In more detail, the second power device 42F refers to the information of the amount of available electric power stored in the storage unit 68 so as to select the second power device 40F (e.g. the second power device 43F, in this situation) affording the largest amount of available electric power from the second power devices 41F and 43F as the destination one to which the failure detection result is transmitted.

When the communication unit 65 of the second power device 43F receives the failure detection result, the CPU 640 of the second power device 43F switches the selection switch 644 to the ground side. Thereby, the second power device 43F is switched to the constant voltage mode from the variable voltage mode.

Consequently, thereafter, the second power device 43F substitutes for the first power device 30F.

As described in the above, according to the power supply apparatus 10F of the present embodiment, the second power device 42F having the largest amount of available electric power is switched from the variable voltage mode to the constant voltage mode when the commercial power source 81 fails to supply power. Therefore, by comparison with the instance where the order is preliminarily determined as in the seventh embodiment, it is possible to decrease the switching number of times that the second power device 40F having its output voltage Vout kept constant (the number of times that the second power device 40F is switched from the variable voltage mode to the constant voltage mode). Consequently, it is possible to suppress an occurrence of a failure (e.g. a decrease of efficiency and/or stability of whole system) caused by the switching between the variable voltage mode and the constant voltage mode. As a result, it is possible to successfully make power supply to the DC device 92.

In the power supply apparatus 10F of the present embodiment, each of the power devices 20 includes the storage unit (the first power device 30F includes the storage unit 55 and the second power devices 40F include the storage unit 68). Herein, the power supply apparatus 10F including the control unit 70 with a storage unit (not shown) is exemplified as a modification of the power supply apparatus 10F of the present embodiment. With this modification, the communication unit 65 sends the information of the amount of available electric power detected by the detection unit 67 to the control unit 70. In addition, the control unit 70 sends the available amount detection result to the second power device 40F having the largest amount of available electric power at that time, with reference to the information of the amount of available electric power stored in its storage unit.

In the power supply apparatus 10F of the present embodiment, all the second power devices 40F include the selection switch 644 and the communication unit 65. However, all the second power devices 40F do not need to include the selection switch 644 and the communication unit 65. In this situation, the first power device 30F is configured to periodically receive the information of the amount of available electric power from the second power devices 40F having the selection switch 644 and the communication unit 65, and store the received information of the amount of available electric power in the storage unit 55. When the detection unit 53 of the first power device 30F detects the failure of the commercial power source 81, the first power source 30F controls the communication unit 54 to send the failure detection result of the detection unit 53 to the second power device 40F. Herein, the second power device 40F as a destination of the available amount detection result is selected with reference to the information of the amount of available electric power stored in the storage unit 55. In short, the destination of the available amount detection result is selected from the second power devices 40F having the selection switch 644 and the communication unit 65.

### Ninth Embodiment

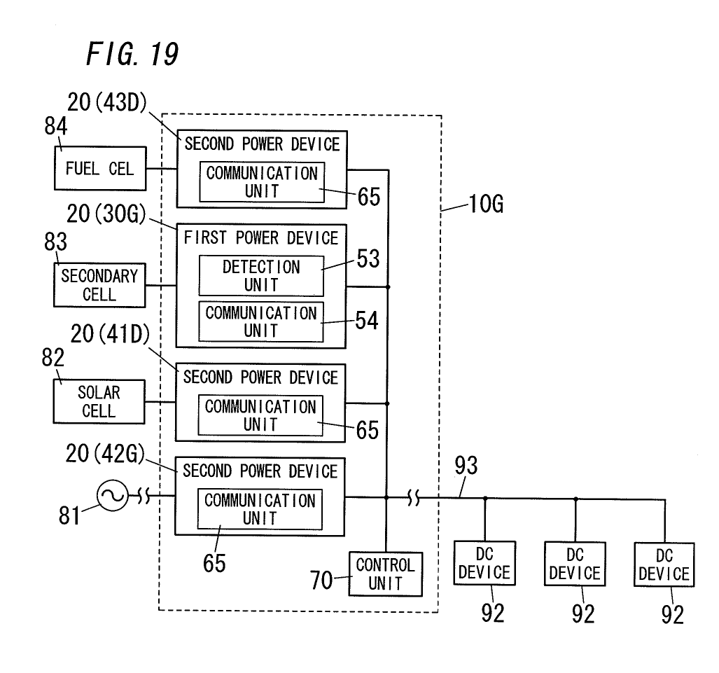

As shown in FIG. 19, the power supply apparatus 10G of the present embodiment includes a total of the four power devices 20, that is, the one first power device 30G, and the three second power devices 41D, 42G, and 43D.

It is noted that the first power device 30G is configured to be activated by the secondary cell 83 as its power source. Further, the second power device 42G is configured to be activated by the commercial power source 81 as its power source. That is, according to the power supply device 10G, the power device connected to the secondary cell 83 is the first power device, and the power device connected to the commercial power source 81 is the second power device. The second power devices 41D and 43D are the same as those of the sixth embodiment. In addition, components which are common to the power supply apparatus 10G of the present embodiment and the power supply apparatus 10D of the sixth embodiment are designated by the same reference numerals as the sixth embodiment, and no explanation thereof is deemed necessary.

Besides, like the sixth embodiment, the power supply apparatus 10G is configured to preliminary determine the order (rank) of the second power devices 41D, 42G, and 43D being switched from the variable voltage mode to the constant voltage mode.

Next, an explanation is made to an operation of the power supply apparatus 10G of the present embodiment. For example, when the detection unit 53 of the first power device 30G detects the amount of available electric power being not greater than the threshold, the first power device 30G controls the communication unit 54 to send the available amount detection result to the second power device (e.g. the second power device 42G, in this situation) having the highest rank from the second power devices 41D, 42G, and 43D. In the second power device 42G, when the communication unit 65 receives the available amount detection result from the first power device 30G, the CPU 640 switches the selection switch 644 to the ground side. Thereby, the second power device 42G is switched from the variable voltage mode to the constant voltage mode. It is noted that the output voltage Vout of the second power device 42G being the constant voltage mode is selected to be identical to the output voltage Vout of the first power device 30G. Consequently, even if a device having a constant output voltage Vout is switched from the first power device 30G to the second power device 42G, no change is seen in the supplied voltage to the DC device 92. Therefore, it is possible to successfully supply an electric power to the DC device 92.

By contrast, when the amount of available electric power exceeds the threshold in the first power device 30G, the communication unit 54 of the first power device 30G sends the available amount detection result to the second power device 42G. In the second power device 42G, when the communication unit 65 receives the available amount detection result from the first power device 30G, the CPU 640 switches the selection switch 644 to the voltage follower 604 side. Thereby, the second power device 42G is switched from the constant voltage mode to the variable voltage mode. In other words, the CPU 640 and the selection switch 644 constitute the switching unit configured to switch the operation mode of the second power device 42G between the constant voltage mode ant the variable voltage mode.

Consequently, in the second power device 42G, the output current-output voltage characteristics are switched when the amount of available electric power of the secondary cell 83 connected to the first power device 30G falls below the threshold.

As described in the above, according to the power supply apparatus 10G, the second power device 42G is switched from the variable voltage mode to the constant voltage mode when the amount of available electric power of the secondary cell 83 connected to the first power device 30G executing the constant voltage control becomes not greater than the threshold. In this situation, the second power device 42G makes the constant voltage control, thereby keeping its output voltage Vout constant. In short, the second power device 42G substitutes for the first power device 30G. Therefore, in a like manner as the amount of available electric current exceeds the threshold (the first power device 30D making power supply), it is possible to successfully make power supply to the DC device 92.

In the power supply apparatus 10G of the present embodiment, the first power device 30G is defined as the power device to be connected to the secondary cell 83, and the second power device 42G is defined as the power device to be connected to the commercial power source 81. This definition can be applied to the power supply apparatus 10E of the seventh embodiment and the power supply apparatus 10F of the eighth embodiment. Alternatively, in the power supply apparatus 10G, the first power device 30G may be defined as either the power device to be connected to the solar cell 82 or the power device to be connected to the fuel cell 84.

1. A power supply apparatus comprising:
a plurality of power devices, each of said power devices being configured to provide an output voltage of a DC voltage,
wherein said power supply apparatus is configured to operate simultaneously said plurality of said power devices to supply a DC power therefrom to a load device to which said power devices are connected,
wherein said plurality of said power devices comprises:
a first power device configured to have output current-output voltage characteristics of keeping an output voltage of said first power device constant irrespective of a magnitude of an output current of said first power device; and
a second power device configured to have output current-output voltage characteristics of decreasing monotonically an output voltage of said second power device with an increase of an output current of said second power device, and
wherein said second power device includes an adjustment unit configure to adjust the output current of said second power device in accordance with an instruction value,
said adjustment unit being configured to, upon receiving the instruction value, modify the output current-output voltage characteristics under a condition where the output voltage decreases monotonically as the output current increases, thereby adjusting the output current to a current corresponding to the received instruction value as well as adjusting the output voltage corresponding to the adjusted output current to the output voltage corresponding to the unadjusted output current.

2. A power supply apparatus as set forth in claim 1, wherein
said second power device includes a control unit configured to output the instruction value,
said instruction value being defined to prescribe a magnitude of the output current of said second power device.

3. A power supply apparatus as set forth in claim 1, wherein
said adjustment unit is configured to modify the output current-output voltage characteristics of said second power device by adjusting the output voltage of the second power device to a voltage obtained by addition of a predetermined voltage to or subtraction of the same from the unadjusted output voltage of the second power device such that the output current of said second power device given in accordance with the modified output current-output voltage characteristics becomes corresponding to the instruction value when the output voltage of said second power device is identical to the output voltage of said first power device.

4. A power supply apparatus as set forth in claim 1, wherein
said first power device includes an AC/DC converter configured to convert a source voltage received from a commercial power source into the DC voltage.

5. A power supply apparatus as set forth in claim 1, wherein
said second power device comprises:
a current detector configured to detect the output current of the second power device;
a voltage detector configured to detect the output voltage of the second power device;
a DC/DC converter including a switching device and configured to make a power conversion by an on-off operation of said switching device;
a switching controller configured to send to said switching device a pulse width modulated signal for controlling the on-off operation of said switching device such that said second power device has a particular output current-output voltage characteristics of decreasing monotonically the output voltage of said second power device with an increase of the output current of said second power device, on the basis of a detection result of said output current detector and a detection result of said output voltage detector.

6. A power supply apparatus as set forth in claim 5, wherein
said adjustment unit is configured to calculate a difference value between a value corresponding to the received instruction value and the detection result of said current detector, and output the calculated difference value to said switching controller, and
said switching controller being configured to modify a duty ratio of the pulse width modulation signal depending on the received difference value and the detection result of said voltage detector.

7. A power supply apparatus as set forth in claim 1, wherein
said adjustment unit is configured to calculate an error between the detection result of said current detector and a value corresponding to the instruction value, and correct the output current-output voltage characteristics to reduce the calculated error under the condition where the output voltage decreases monotonically as the output current increases.

8. A power supply apparatus as set forth in claim 1, wherein
said adjustment unit is configured to modify the output current-output voltage characteristics to reduce an increase rate of the output voltage relative to a decrease of the output current when the output voltage of the second power device becomes equal to a prescribed threshold.

9. A power supply apparatus as set forth in claim 3, wherein
said first power device includes an AC/DC converter configured to convert a source voltage from a commercial power source into a DC voltage.

10. A power supply apparatus as set forth in claim 3, wherein
said second power device comprises:
a current detector configured to detect the output current of the second power device;
a voltage detector configured to detect the output voltage of the second power device;
a DC/DC converter including a switching device and configured to make a power conversion by an on-off operation of said switching device;
a switching controller configured to send to said switching device a pulse width modulated signal for controlling the on-off operation of said switching device such that said second power device has a particular output current-output voltage characteristics of decreasing monotonically the output voltage of said second power device with an increase of the output current of said second power device, on the basis of a detection result of said output current detector and a detection result of said output voltage detector.

11. A power supply apparatus as set forth in claim 10, wherein
said adjustment unit is configured to calculate a difference value between a value corresponding to the received instruction value and the detection result of said current detector, and output the calculated difference value to said switching controller, and
said switching controller being configured to modify a duty ratio of the pulse width modulation signal depending on the received difference value and the detection result of said voltage detector.

12. A power supply apparatus as set forth in claim 3, wherein
said adjustment unit is configured to calculate an error between the detection result of said current detector and a value corresponding to the instruction value, and correct the output current-output voltage characteristics to reduce the calculated error under the condition where the output voltage decreases monotonically as the output current increases.

13. A power supply apparatus as set forth in claim 3, wherein
said adjustment unit is configured to modify the output current-output voltage characteristics to reduce an increase rate of the output voltage relative to a decrease of the output current when the output voltage of the second power device becomes equal to a prescribed threshold.
